(19) United States
(12) Patent Application Publication
(10) Pub. No.: US 2023/0388157 A1
(43) Pub. Date: Nov. 30, 2023

(54) EIGENVALUE DECOMPOSITION APPARATUS, RADIO COMMUNICATION APPARATUS, METHOD, AND NON-TRANSITORY COMPUTER READABLE MEDIUM

(71) Applicant: NEC Corporation, Minato-ku, Tokyo (JP)

(72) Inventors: Jun Shikida, Tokyo (JP); Kazushi Muraoka, Tokyo (JP)

(73) Assignee: NEC Corporation, Minato-ku, Tokyo (JP)

(21) Appl. No.: 18/031,253

(22) PCT Filed: Oct. 27, 2020
(86) PCT No.: PCT/JP2020/040318

§ 371 Date: Apr. 11, 2023

(51) Int. Cl. H04L 25/02; G06F 17/16

(52) U.S. Cl. CPC H04L 25/0248; G06F 17/16

(57) ABSTRACT

An eigenvalue decomposition apparatus includes: first generation means for inputting a first matrix and generating a 2×2-dimensional third matrix using a plurality of elements included in a second matrix based on the first matrix; first calculation means for calculating a two-dimensional eigenvector that corresponds to a maximum eigenvalue of the third matrix; first update means for generating a fourth matrix obtained by reducing the dimension of the second matrix by using the two-dimensional eigenvector, updating the second matrix based on the fourth matrix, and determining, when the number of elements included in the fourth matrix is one, the element included in the fourth matrix to be an eigenvalue of the first matrix; and second calculation means for determining the eigenvector of the first matrix using the two-dimensional eigenvectors calculated before the number of elements included in the fourth matrix becomes one.

### TECHNICAL FIELD

The present disclosure relates to an eigenvalue decomposition apparatus, a radio communication apparatus, a method, and a non-transitory computer readable medium.

### BACKGROUND ART

Eigenvalue decomposition is used in an extremely wide range of fields such as chemical calculation, statistical calculation, information search, and the like. A power method and the Jacobi method are generally known as an eigenvalue decomposition method for a real symmetric matrix or a Hermitian matrix. A method for obtaining an eigenvalue and an eigenvector of a matrix via a tridiagonal matrix is also known as the eigenvalue decomposition method for the real symmetric matrix or the Hermitian matrix. With regard to a method via the tridiagonal matrix, Patent Literature 1 discloses repeating, for a symmetric tridiagonal matrix, division of the symmetric tridiagonal matrix and eigenvalue decomposition on the symmetric tridiagonal matrices after the division, thus obtaining the eigenvalue and the eigenvector of the original symmetric tridiagonal matrix.

### CITATION LIST

### Patent Literature

[Patent Literature 1] Japanese Patent No. 5017666

### SUMMARY OF INVENTION

### Technical Problem

The general eigenvalue decomposition method described above or the eigenvalue decomposition method disclosed in Patent Literature 1 requires a large amount of computation. Accordingly, if any one of the aforementioned eigenvalue decomposition methods is used when, for example, it is required to perform eigenvalue decomposition within a short period of time, it is possible that the eigenvalue decomposition may not be completed within the required time.

The present disclosure has been made in order to solve the aforementioned problem and one of the objects of the present disclosure is to provide an eigenvalue decomposition apparatus, a radio communication apparatus, a method, and a non-transitory computer readable medium capable of performing eigenvalue decomposition at a high speed.

### Solution to Problem

An eigenvalue decomposition apparatus according to the present disclosure includes: first generation means for inputting a first matrix and generating a 2×2-dimensional third matrix using a plurality of elements included in a second matrix based on the first matrix; first calculation means for calculating a two-dimensional eigenvector that corresponds to a maximum eigenvalue of the third matrix; first update means for generating a fourth matrix obtained by reducing the dimension of the second matrix by using the two-dimensional eigenvector, updating the second matrix based on the fourth matrix, and determining, when the number of elements included in the fourth matrix is one, the element included in the fourth matrix to be an eigenvalue of the first matrix; and second calculation means for determining the eigenvector of the first matrix using the two-dimensional eigenvectors calculated before the number of elements included in the fourth matrix becomes one.

A radio communication apparatus according to the present disclosure includes: the aforementioned eigenvalue decomposition apparatus; channel estimation means for estimating a channel response between the radio communication apparatus and a radio terminal and generating a channel matrix based on the estimated channel response; correlation matrix calculation means for calculating the first matrix using the channel matrix; and transmission signal generation means for determining a weight coefficient based on the eigenvector and generating a signal multiplied by the weight coefficient, in which the eigenvalue decomposition apparatus further includes removal means for removing a component that corresponds to the eigenvalue of the first matrix from the first matrix and updating the first matrix based on a matrix obtained by removing the component from the first matrix, the second calculation means outputs, when the number of eigenvectors becomes a predetermined number, the predetermined number of eigenvectors, and the transmission signal generation means determines the weight coefficient based on the predetermined number of eigenvectors.

A method according to the present disclosure includes: inputting a first matrix and generating a 2×2-dimensional third matrix using at least one element included in a second matrix based on the first matrix; calculating a two-dimensional eigenvector that corresponds to a maximum eigenvalue of the third matrix; generating a fourth matrix obtained by reducing the dimension of the second matrix by using the two-dimensional eigenvector, updating the second matrix based on the fourth matrix, and determining, when the number of elements included in the fourth matrix is one, the element included in the fourth matrix as a first eigenvalue of the first matrix; and determining the eigenvector of the first matrix using the two-dimensional eigenvectors calculated before the number of elements included in the fourth matrix becomes one.

A non-transitory computer readable medium according to the present disclosure is a non-transitory computer readable medium storing a program for causing a computer to execute the following processing of: inputting a first matrix and generating a 2×2-dimensional third matrix using at least one element included in a second matrix based on the first matrix; calculating a two-dimensional eigenvector that corresponds to a maximum eigenvalue of the third matrix; generating a fourth matrix obtained by reducing the dimension of the second matrix by using the two-dimensional eigenvector, updating the second matrix based on the fourth matrix, and determining, when the number of elements included in the fourth matrix is one, the element included in the fourth matrix as a first eigenvalue of the first matrix; and determining the eigenvector of the first matrix using the two-dimensional eigenvectors calculated before the number of elements included in the fourth matrix becomes one.

### Advantageous Effects of Invention

According to the present disclosure, it is possible to provide an eigenvalue decomposition apparatus, a radio communication apparatus, a method, and a non-transitory computer readable medium capable of performing eigenvalue decomposition at a high speed.

### BRIEF DESCRIPTION OF DRAWINGS

FIG. 1 is a diagram showing a configuration example of an eigenvalue decomposition apparatus according to a first example embodiment;

FIG. 2 is a flowchart showing an operation example of the eigenvalue decomposition apparatus according to the first example embodiment;

FIG. 3 is a diagram showing a configuration example of an information processing system according to a second example embodiment;

FIG. 4 is a diagram for describing an overview of an operation example of an eigenvalue decomposition apparatus according to the second example embodiment;

FIG. 5 is a flowchart showing an operation example of the eigenvalue decomposition apparatus according to the second example embodiment;

FIG. 6 is a diagram showing a configuration example of an information processing system according to a third example embodiment;

FIG. 7 is a flowchart showing an operation example of an eigenvalue decomposition apparatus according to the third example embodiment;

FIG. 8 is a diagram showing a configuration example of a radio communication system according to a fourth example embodiment;

FIG. 9 is a diagram showing a configuration example of a radio communication apparatus according to the fourth example embodiment;

FIG. 10 is a flowchart showing an operation example of the radio communication apparatus according to the fourth example embodiment; and

FIG. 11 is a diagram showing a hardware configuration example of an eigenvalue decomposition apparatus and the like according to each example embodiment of the present disclosure.

### EXAMPLE EMBODIMENT

In the following, with reference to the drawings, example embodiments of the present disclosure will be described in detail. The following descriptions and the drawings are omitted and simplified as appropriate for the sake of clarification of the description. Further, throughout the drawings, the same elements are denoted by the same reference symbols and overlapping descriptions are be omitted as necessary.

### First Example Embodiment

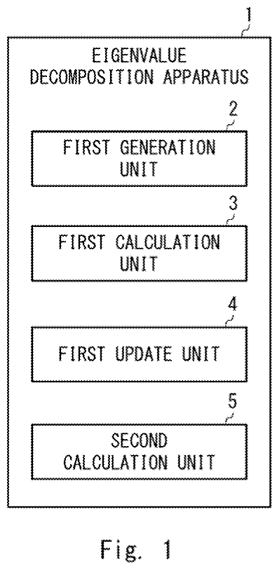

With reference to FIG. 1, a configuration example of an eigenvalue decomposition apparatus 1 according to a first example embodiment will be described. FIG. 1 is a diagram showing a configuration example of the eigenvalue decomposition apparatus according to the first example embodiment. The eigenvalue decomposition apparatus 1 receives a first matrix on which eigenvalue decomposition is to be performed and performs eigenvalue decomposition. The eigenvalue decomposition apparatus 1 may be, for example, an information processing apparatus that performs chemical calculation, statistical calculation, information search, and the like. The eigenvalue decomposition apparatus 1 includes a first generation unit 2, a first calculation unit 3, a first update unit 4, and a second calculation unit 5.

The first generation unit 2 functions as an input unit as well and inputs a first matrix. The first matrix may be a real symmetric matrix or may be a Hermitian matrix. The first generation unit 2 may be configured to include an input apparatus such as a keyboard or a mouse and input the first matrix using the input apparatus. Alternatively, the first generation unit 2 may be configured to include an interface with an external apparatus such as an input apparatus and input the first matrix by receiving, from the external apparatus, the first matrix input to the external apparatus.

The first generation unit 2 generates a 2×2-dimensional third matrix using a plurality of elements included in a second matrix which is based on the first matrix. After inputting the first matrix, the first generation unit 2 generates a second matrix in which the first matrix is an initial matrix, and generates a third matrix based on this second matrix. When the first update unit 4 that will be described later has updated the second matrix, the first generation unit 2 generates a third matrix based on the updated second matrix.

The first calculation unit 3 calculates a two-dimensional eigenvector that corresponds to the maximum eigenvalue of the third matrix generated by the first generation unit 2.

The first update unit 4 generates a fourth matrix obtained by reducing the dimension of the second matrix using the two-dimensional eigenvector calculated by the first calculation unit 3, and updates the second matrix based on the fourth matrix. The first update unit 4 updates the fourth matrix in such a way that the fourth matrix becomes a second new matrix. The first update unit 4 combines, of the rows and the columns included in the second matrix, two rows and two columns that correspond to the third matrix, reduces the dimension of the second matrix, and generates the fourth matrix in which the dimension is reduced. The first update unit 4 determines, when the number of elements included in the fourth matrix is one, the element included in the fourth matrix as the eigenvalue of the first matrix. Since “reduce the dimension” means “decrease the dimension” or “diminish the dimension”, the phrase “reduce the dimension” may be replaced by a phrase “decrease the dimension” or “diminish the dimension” in the following descriptions.

The first update unit 4 may function as an output unit as well and output the eigenvalue of the first matrix. The first update unit 4 may be configured so as to include an output apparatus such as a display and output the eigenvalue of the first matrix to the output apparatus. Alternatively, the first update unit 4 may be configured to include an interface with an external apparatus such as an output apparatus and output the eigenvalue of the first matrix to the external apparatus.

The second calculation unit 5 determines the eigenvector of the first matrix using two-dimensional eigenvectors calculated before the number of elements included in the fourth matrix becomes one. The second calculation unit 5 holds the two-dimensional eigenvectors calculated by the first calculation unit 3. When the number of elements included in the fourth matrix is one, the second calculation unit 5 determines the eigenvector of the first matrix using the two-dimensional eigenvector that is held.

The second calculation unit 5 may function as an output unit as well and output the eigenvector of the first matrix. The second calculation unit 5 may be configured to include an output apparatus such as a display and output the eigenvector of the first matrix to the output apparatus. Alternatively, the second calculation unit 5 may be configured to include, for example, an interface with an external apparatus such as an output apparatus and output the eigenvector of the first matrix to the external apparatus. Alternatively, the second calculation unit 5 may acquire the eigenvalue of the first matrix from the first update unit 4 and output the eigenvalue and the eigenvector of the first matrix.

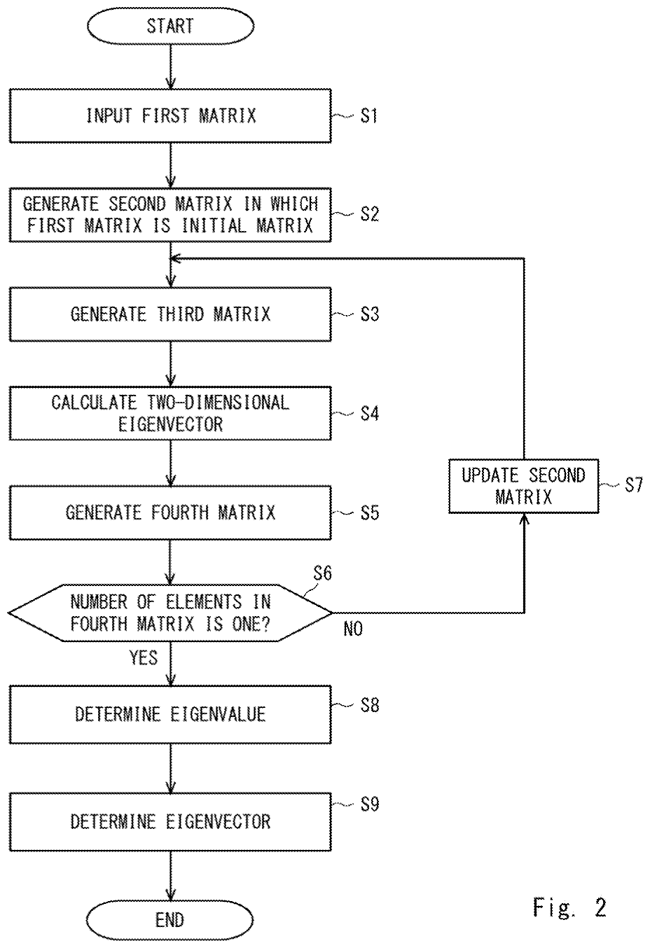

Referring next to FIG. 2, an operation example of the eigenvalue decomposition apparatus 1 according to the first example embodiment will be described. FIG. 2 is a flowchart showing an operation example of the eigenvalue decomposition apparatus according to the first example embodiment.

The first generation unit 2 inputs a first matrix (Step S1). The first matrix may be a real symmetric matrix or may be a Hermitian matrix.

The first generation unit 2 generates a second matrix in which the first matrix is an initial matrix (Step S2).

The first generation unit 2 extracts a plurality of elements included in the second matrix and generates a 2×2-dimensional third matrix using the extracted elements (Step S3).

The first calculation unit 3 calculates a two-dimensional eigenvector that corresponds to the maximum eigenvalue of the third matrix (Step S4).

The first update unit 4 generates a fourth matrix obtained by reducing the dimension of the second matrix using the two-dimensional eigenvector (Step S5).

The first update unit 4 determines whether the number of elements included in the fourth matrix is one (Step S6).

When the number of elements included in the fourth matrix is not one (NO in Step S6), the first update unit 4 updates the second matrix based on the fourth matrix (Step S7) and the eigenvalue decomposition apparatus 1 executes Step S3 and the following steps. That is, the eigenvalue decomposition apparatus 1 repeatedly executes the generation of the third matrix, the calculation of the two-dimensional eigenvector, and the update of the second matrix until when the number of elements included in the fourth matrix becomes one.

On the other hand, when the number of elements included in the fourth matrix is one (YES in Step S6), the first update unit 4 determines the element included in the fourth matrix as the eigenvalue of the first matrix (Step S8). In Step S8, the first update unit 4 may output the eigenvalue of the first matrix.

The second calculation unit 5 determines the eigenvector of the first matrix using two-dimensional eigenvectors calculated before the number of elements included in the fourth matrix becomes one (Step S9). The second calculation unit 5 holds the two-dimensional eigenvector calculated in Step S4 every time Step S4 is executed. When the number of elements included in the fourth matrix is one, the second calculation unit 5 determines the eigenvector of the first matrix using the two-dimensional eigenvector that is held. In Step S9, the second calculation unit 5 may output the eigenvector of the first matrix. Alternatively, the second calculation unit 5 may acquire the eigenvalue of the first matrix from the first update unit 4 and output the eigenvalue and the eigenvector of the first matrix in Step S9.

The eigenvalue decomposition apparatus 1 calculates a two-dimensional eigenvector for the 2×2-dimensional third matrix from the second matrix which is based on the first matrix on which eigenvalue decomposition is to be performed, and reduces the dimension of the second matrix that uses the calculated two-dimensional eigenvector. The eigenvalue decomposition apparatus 1 obtains the eigenvalue and the eigenvector of the first matrix by repeating the calculation of the two-dimensional eigenvector and the reduction of the dimension of the second matrix. The eigenvalue decomposition apparatus 1 reduces the dimension of the second matrix by combining the two column vectors and the two row vectors of the second matrix using the calculated two-dimensional eigenvector.

While the eigenvalue eventually obtained becomes an approximate solution, the eigenvalue decomposition apparatus 1 is able to calculate the eigenvalue and the eigenvector of the first matrix with a small amount of computation by the eigenvalue decomposition of the 2×2-dimensional matrix and the linear combination of vectors. In other words, the eigenvalue decomposition apparatus 1 is able to calculate the eigenvalue and the eigenvector of the first matrix by performing the eigenvalue decomposition of the 2×2-dimensional matrix and the linear combination of vectors which require a small amount of computation instead of performing computation such as a product of a matrix and a vector and matrix multiplication which require a large amount of computation. Accordingly, with the eigenvalue decomposition apparatus 1 according to the first example embodiment, it is possible to reduce the amount of computation required for the eigenvalue decomposition and perform eigenvalue decomposition at a high speed.

### Second Example Embodiment

Next, a second example embodiment will be described. The second example embodiment is an example embodiment in which the first example embodiment is made more specific.

### Configuration Example of Information Processing System

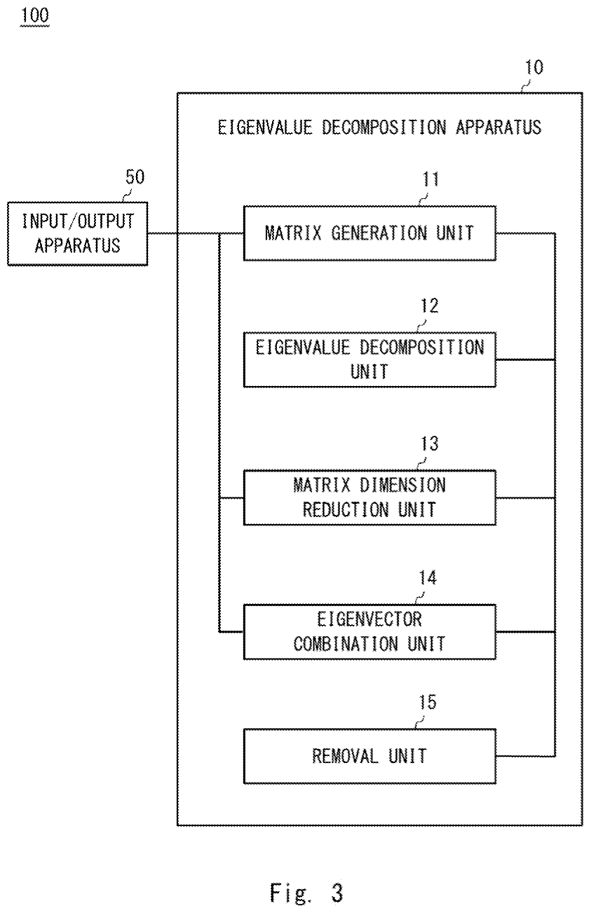

Referring to FIG. 3, a configuration example of an information processing system 100 according to the second example embodiment will be described. FIG. 3 is a diagram showing a configuration example of the information processing system according to the second example embodiment. The information processing system 100 includes an input/output apparatus 50 and an eigenvalue decomposition apparatus 10. The information processing system 100 may also be referred to as a computer system since the eigenvalue decomposition apparatus 10 obtains an eigenvalue and an eigenvector of a matrix input from the input/output apparatus 50.

The input/output apparatus 50 is, for example, an apparatus including an input apparatus and an output apparatus such as a mouse, a keyboard, a display and the like. The input/output apparatus 50 inputs a real symmetric matrix or a Hermitian matrix by, for example, a user operation. The input/output apparatus 50 outputs the input real symmetric matrix or Hermitian matrix to the eigenvalue decomposition apparatus 10. The input/output apparatus 50 outputs the eigenvalue and the eigenvector output from the eigenvalue decomposition apparatus 10.

The eigenvalue decomposition apparatus 10 receives a matrix on which eigenvalue decomposition is to be performed from the input/output apparatus 50 and inputs the received matrix. The matrix on which eigenvalue decomposition is to be performed may be a real symmetric matrix or may be a Hermitian matrix. The eigenvalue decomposition apparatus 10 determines the eigenvalue and the eigenvector of the input matrix and outputs the determined eigenvalue and eigenvector to the input/output apparatus 50. While the information processing system 100 is configured to include the input/output apparatus 50, the information processing system 100 may be configured not to include the input/output apparatus 50. That is, the eigenvalue decomposition apparatus 10 may be configured to include the input apparatus and the output apparatus, input a matrix on which eigenvalue decomposition is to be performed, and output the eigenvalue and the eigenvector to the output apparatus.

### Configuration Example of Eigenvalue Decomposition Apparatus

Next, a configuration example of the eigenvalue decomposition apparatus 10 will be described. The eigenvalue decomposition apparatus 10 includes a matrix generation unit 11, an eigenvalue decomposition unit 12, a matrix dimension reduction unit 13, an eigenvector combination unit 14, and a removal unit 15.

The matrix generation unit 11 corresponds to the first generation unit 2 according to the first example embodiment. The matrix generation unit 11 receives a matrix on which eigenvalue decomposition is to be performed as a matrix A from the input/output apparatus 50. The matrix on which eigenvalue decomposition is to be performed may be a real symmetric matrix or may be a Hermitian matrix.

The matrix generation unit 11 generates a matrix B in which the matrix A input from the input/output apparatus 50 is an initial matrix. Further, the matrix generation unit 11 inputs, when the removal unit 15 that will be described later has updated the matrix A, the matrix A updated by the removal unit 15 and generates a matrix B in which the updated matrix A is an initial matrix. The matrix generation unit 11 extracts, from among the elements included in the matrix B, two diagonal elements, and two non-diagonal elements, one of which being positioned in the same row as one of the two diagonal elements and the other one of which being positioned in the same column as the other one of the two diagonal elements, and then generates a matrix C, which is a 2×2-dimensional matrix. Specifically, the matrix generation unit 11 extracts a diagonal element in the i (i: an integer equal to or larger than one)-th row and i-th column, a diagonal element in the j (j: an integer equal to or larger than one, i<j)-th row and the j-th column, a non-diagonal element in the i-th row and the j-th column, and a non-diagonal element in the j-th row and i-th column included in the matrix B. The matrix generation unit 11 generates a matrix C, which is a 2×2-dimensional matrix having the extracted elements as the respective elements.

The matrix generation unit 11 outputs the generated the matrix C, which is a 2×2-dimensional matrix, to the eigenvalue decomposition unit 12. Further, the matrix generation unit 11 outputs the matrix B and information regarding the positions of the elements extracted from the matrix B (the row number and the column number) to the matrix dimension reduction unit 13. The matrix generation unit 11 extracts the diagonal element in the i-th row and the i-th column, the diagonal element in the j-th row and the j-th column, the non-diagonal element in the i-th row and the j-th column, and the non-diagonal element in the j-th row and i-th column. Therefore, the information regarding the positions of the elements extracted from the matrix B includes information indicating the i-th row and the i-th column, the j-th row and the j-th column, the i-th row and the j-th column, and the j-th row and the i-th column. The matrix generation unit 11 outputs the matrix A to the removal unit 15. In the following description, the information regarding the positions of the elements extracted from the matrix B may be referred to as extracted element information.

The matrix generation unit 11 inputs, when the matrix dimension reduction unit 13 that will be described later has updated the matrix B, the updated matrix B and generates a matrix C, which is a 2×2-dimensional matrix, based on the updated matrix B. The matrix generation unit 11 extracts, from among the elements included in the updated matrix B, two diagonal elements, and two non-diagonal elements, one of which being positioned in the same row as one of the two diagonal elements and the other one of which being positioned in the same column as the other one of the two diagonal elements, and then generates a matrix C, which is a 2×2-dimensional matrix. The matrix generation unit 11 outputs the generated matrix C, which is a 2×2-dimensional matrix, to the eigenvalue decomposition unit 12.

The eigenvalue decomposition unit 12 corresponds to the first calculation unit 3 according to the first example embodiment. The eigenvalue decomposition unit 12 calculates the two-dimensional eigenvector that corresponds to the maximum eigenvalue of the matrix C, which is a 2×2-dimensional matrix, input from the matrix generation unit 11. The eigenvalue decomposition unit 12 outputs the calculated two-dimensional eigenvector to the matrix dimension reduction unit 13. Since the eigenvalue decomposition unit 12 calculates the two-dimensional eigenvector that corresponds to the maximum eigenvalue of the matrix C, which is a 2×2-dimensional matrix, the eigenvalue decomposition unit 12 may be referred to as a 2×2-dimensional matrix eigenvalue decomposition unit.

The matrix dimension reduction unit 13 corresponds to the first update unit 4 according to the first example embodiment. The matrix dimension reduction unit 13 reduces the dimension of the matrix B using the matrix B input from the matrix generation unit 11, the extracted element information, and the two-dimensional eigenvector input from the eigenvalue decomposition unit 12, and generates a matrix D obtained by reducing the dimension of the matrix B. The matrix dimension reduction unit 13 composes, of the matrix B, two rows and two columns of the row number and/or column number included in the extracted element information, reduces the dimension of the matrix B, and then generates a matrix D. Since the matrix generation unit 11 extracts the elements in the i-th row and the i-th column, the j-th row and the j-th column, the i-th row and the j-th column, and the j-th row and the i-th column, the extracted element information includes i and j. The matrix dimension reduction unit 13 composes the i-th row and the j-th row of the matrix B, composes the i-th column and the j-th column of the matrix B, reduces the dimension of the matrix B, and generates a matrix D. It can also be said that the matrix dimension reduction unit 13 combines the i-th row and the j-th row in one row. Therefore, in the following description, “compose” may also be referred to as “combine”. Further, the aforementioned term “and/or” includes any and all combinations of one or more of the items listed in association with each other. The same is applicable to the following descriptions as well.

The matrix dimension reduction unit 13 updates, when the dimension of the matrix D obtained by reducing the dimension of the matrix B is 2×2 dimension or larger, the matrix B based on the matrix D and outputs the updated matrix B to the matrix generation unit 11. That is, when the number of elements included in the matrix D is two or larger, the matrix dimension reduction unit 13 updates the matrix B in such a way that the matrix D becomes a new matrix B. The matrix dimension reduction unit 13 determines, when the dimension of the matrix D obtained by reducing the dimension of the matrix B is 1×1-dimension, the matrix D as the eigenvalue of the matrix A, and outputs this determined eigenvalue to the eigenvector combination unit 14. That is, the matrix dimension reduction unit 13 determines, when the number of elements included in the matrix D is one, the element included in the matrix D to be the eigenvalue of the matrix A and outputs this determined eigenvalue to the eigenvector combination unit 14. The matrix dimension reduction unit 13 outputs the extracted element information and the two-dimensional eigenvector to the eigenvector combination unit 14.

The eigenvector combination unit 14 corresponds to the second calculation unit 5 according to the first example embodiment. The eigenvector combination unit 14 calculates the eigenvector of the matrix A using the extracted element information and the two-dimensional eigenvector input from the matrix dimension reduction unit 13. The eigenvector combination unit 14 determines the eigenvector of the matrix A using the unit matrix whose dimension is the same as that of the matrix A and two elements included in the two-dimensional eigenvector.

The eigenvector combination unit 14 determines whether the number of eigenvalues of the matrix A and the number of eigenvectors of the matrix A are a predetermined number. Since the number of eigenvalues of the matrix A is the same as the number of eigenvectors of the matrix A, the eigenvector combination unit 14 may determine whether the number of eigenvalues of the matrix A is a predetermined number or may determine whether the number of eigenvectors of the matrix A is a predetermined number.

When the number of eigenvalues of the matrix A and the number of eigenvectors of the matrix A become equal to the predetermined number, the eigenvector combination unit 14 outputs the eigenvalue of the matrix A and the eigenvector of the matrix A to the input/output apparatus 50. On the other hand, when the number of eigenvalues of the matrix A and the number of eigenvectors of the matrix A have not reached the predetermined number, the eigenvector combination unit 14 outputs the eigenvalue of the matrix A and the eigenvector of the matrix A to the removal unit 15.

The removal unit 15 removes the component that corresponds to the input eigenvalue from the matrix A using the matrix A input from the matrix generation unit 11, and the eigenvalue of the matrix A and the eigenvector of the matrix A input from the eigenvector combination unit 14. The removal unit 15 updates the matrix A based on the matrix A from which the component that corresponds to the eigenvalue of the matrix A has been removed. In other words, the removal unit 15 updates the matrix A in such a way that the matrix A from which the component that corresponds to the eigenvalue of the matrix A has been removed becomes a new matrix A and outputs the updated matrix A to the matrix generation unit 11. That is, the removal unit 15 updates the matrix A in such a way that the updated matrix A becomes the initial matrix of the matrix B. In the following description, “the matrix A from which the component that corresponds to the eigenvalue of the matrix A has been removed” may be referred to as “the matrix A from which the eigenvalue component has been removed”.

### Operation Example of Eigenvalue Decomposition Apparatus

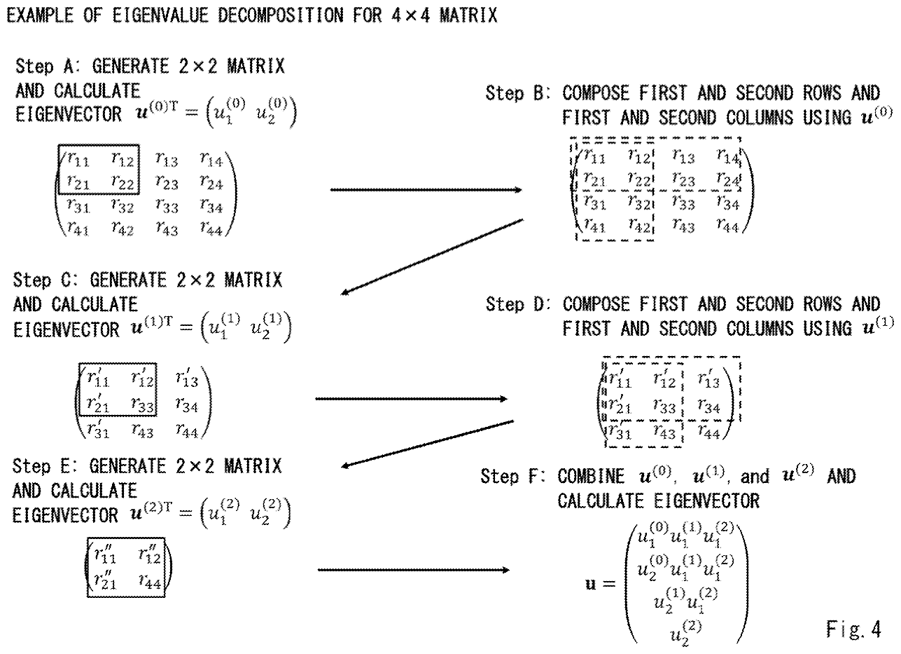

Next, an operation example of the eigenvalue decomposition apparatus 10 will be described. Prior to giving the description of details of the operation example of the eigenvalue decomposition apparatus 10, with reference to FIG. 4, an overview of an operation performed by the eigenvalue decomposition apparatus 10 will be described. FIG. 4 is a diagram for describing the overview of an operation example of the eigenvalue decomposition apparatus according to the second example embodiment. FIG. 4 is a diagram showing an overview of an operation when a 4×4 matrix is input to the eigenvalue decomposition apparatus 10 as a matrix A as one example.

In Step A, the matrix generation unit 11 generates a matrix B in which the matrix A is the initial matrix. The 4×4 matrix described in Step A shows the initial matrix of the matrix B. The matrix generation unit 11 extracts two diagonal elements and two non-diagonal elements from the matrix B and generates a matrix C, which is a 2×2 matrix. It is assumed that the matrix generation unit 11 has extracted, for example, r₁₁ and r₂₂, which are diagonal elements, and has extracted r₁₂ and r₂₁, which are non-diagonal elements. The matrix generation unit 11 generates a matrix C, which is a 2×2-dimensional matrix, having r₁₁, r₂₂, r₁₂, and r₂₁ as elements. The eigenvalue decomposition unit 12 calculates a two-dimensional eigenvector u⁽⁰⁾ that corresponds to the maximum eigenvalue of the matrix C, which is a 2×2 matrix. While the matrix generation unit 11 extracts two diagonal elements r₁₁ and r₂₂ whose positions are adjacent to each other in FIG. 4, the matrix generation unit 11 may instead extract two desired diagonal elements such as two diagonal elements whose positions are away from each other.

In Step B, the matrix dimension reduction unit 13 composes, of the matrix B, the rows and the columns including the elements extracted in Step A, and generates a matrix D obtained by reducing the dimension of the matrix B. In Step A, the matrix generation unit 11 extracts the diagonal element in the first row and the first column, the diagonal element in the second row and the second column, the non-diagonal element in the first row and the second column, and the non-diagonal element in the second row and the first column. Therefore, the matrix dimension reduction unit 13 composes the first and second rows of the matrix B and composes the first and second columns of the matrix B, and generates a matrix D, which is a 3×3-dimensional matrix, whose dimension is reduced compared to that in the matrix B in Step A. The matrix dimension reduction unit 13 updates the matrix B in such a way that the matrix D becomes a new matrix B. The matrix B after it is updated by the matrix dimension reduction unit 13 is a 3×3-dimensional matrix described in Step C.

In Step C, the matrix generation unit 11 extracts two diagonal elements and two non-diagonal elements from the matrix B, which is a 3×3 matrix that has been updated, and generates a matrix C, which is a 2×2-dimensional matrix. When it is assumed that the matrix generation unit 11 has extracted, for example, r′₁₁ and r₃₃, which are diagonal elements and extracted r′₁₂ and r′₂₁, which are non-diagonal elements, the matrix generation unit 11 generates a matrix C, which is a 2×2-dimensional matrix having r′₁₁, r′₃₃, r′₁₂, and r′₂₁ as elements. The eigenvalue decomposition unit 12 calculates a two-dimensional eigenvector u⁽¹⁾ that corresponds to the maximum eigenvalue of the matrix C.

In Step D, the matrix dimension reduction unit 13 composes, of the matrix B, the rows and the columns including the elements extracted in Step C, and generates a matrix D obtained by reducing the dimension of the matrix B. In Step C, the matrix generation unit 11 extracts the diagonal element in the first row and the first column, the diagonal element in the second row and the second column, the non-diagonal element in the first row and the second column, and the non-diagonal element in the second row and the first column. Therefore, the matrix dimension reduction unit 13 composes the first and second rows of the matrix B, composes the first and second columns of the matrix B, and generates a matrix D, which is a 2×2-dimensional matrix whose dimension is reduced compared to the matrix B in Step C. The matrix dimension reduction unit 13 updates the matrix B in such a way that the matrix D becomes a new matrix B. The matrix B after it is updated by the matrix dimension reduction unit 13 is a 2×2-dimensional matrix described in Step E.

In Step E, like in Steps A and C, the matrix generation unit 11 generates a matrix C, which is a 2×2-dimensional matrix, and the eigenvalue decomposition unit 12 calculates a two-dimensional eigenvector u⁽²⁾ that corresponds to the maximum eigenvalue of the matrix C, like in Steps B and D. While not shown in FIG. 4, the matrix dimension reduction unit 13 composes, of the matrix B, the rows and the columns including the elements extracted in Step E, and generates a matrix D obtained by reducing the dimension of the matrix B. When the matrix dimension reduction unit 13 reduces the dimension from the matrix B of the Step E, the matrix D becomes a 1×1-dimensional matrix and the number of elements included in the matrix D becomes one.

When the number of elements included in the matrix D becomes one, the eigenvector combination unit 14 executes Step F. In Step F, the eigenvector combination unit 14 combines eigenvectors calculated before the number of elements included in the matrix D becomes one, calculates the eigenvector of the matrix A, and determines the eigenvector. In FIG. 4, the eigenvalue decomposition unit 12 calculates the two-dimensional eigenvectors u⁽⁰⁾, u⁽¹⁾, and u⁽²⁾ before the number of elements included in the matrix D becomes one. Therefore, the eigenvector combination unit 14 combines the two-dimensional eigenvectors u⁽⁰⁾, u⁽¹⁾, and u⁽²⁾ and determines the eigenvector of the matrix A.

After one eigenvalue and one eigenvector are determined, the removal unit 15 removes, from the matrix A, the component of the eigenvalue that has been determined, and updates the matrix A in such a way that the matrix A from which the component of the eigenvalue has been removed becomes a new matrix A. In other words, the removal unit 15 updates the matrix A in such a way that the updated matrix A becomes the initial matrix of the matrix B. The eigenvalue decomposition apparatus 10 repeatedly executes the aforementioned operations until a predetermined number of eigenvalues and a predetermined number of eigenvectors are determined.

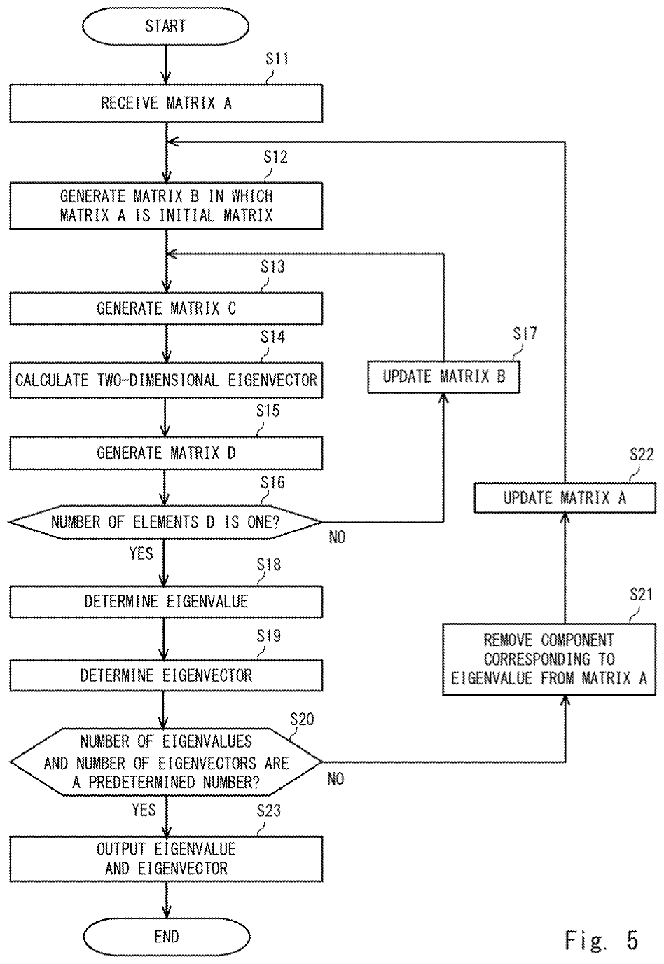

Referring next to FIG. 5, details of an operation example of the eigenvalue decomposition apparatus 10 will be described. FIG. 5 is a flowchart showing the operation example of the eigenvalue decomposition apparatus according to the second example embodiment.

The matrix generation unit 11 receives a matrix on which eigenvalue decomposition is to be performed as a matrix A from the input/output apparatus 50 (Step S11) and generates a matrix B in which the matrix A is the initial matrix (Step S12). When the removal unit 15 has updated the matrix A, the matrix generation unit 11 generates a matrix B in which the updated matrix A is the initial matrix.

The matrix generation unit 11 extracts, from among the elements of the matrix B, two diagonal elements, and two non-diagonal elements, one of which being positioned in the same row as one of the two diagonal elements and the other one of which being positioned in the same column as the other one of the two diagonal elements, and then generates a matrix C, which is a 2×2-dimensional matrix (Step S13). The matrix generation unit 11 extracts, from among the elements of the matrix B, the element (i,i), the element (j,j), the element (i,j), the element (j,i), and generates a 2×2-dimensional matrix. The matrix generation unit 11 generates extracted element information including information indicating (i,i), (j,j), (i,j), and (j,i), which are the positions of the elements extracted from the matrix B. The matrix generation unit 11 outputs the matrix B and the extracted element information to the matrix dimension reduction unit 13.

The matrix generation unit 11 may determine two integers i and j at random and determine elements to be extracted from the matrix B. The matrix generation unit 11 may determine two integers i and j in such a way that elements that correspond to the rows and the columns combined in the matrix dimension reduction unit 13 are not continuously selected, and determine the elements to be extracted from the matrix B. Further, the matrix generation unit 11 may determine two integers i and j based on the magnitude of the elements included in the matrix B and determine the elements to be extracted from the matrix B. The matrix generation unit 11 may extract, for example, non-diagonal elements of the matrix B whose magnitude is the largest as the non-diagonal elements of the 2×2-dimensional matrix, and extract diagonal elements that correspond to the above two non-diagonal elements. The larger the non-diagonal element of the 2×2-dimensional matrix is, the larger the difference between the maximum eigenvalue of the 2×2-dimensional matrix and the minimum eigenvalue of the 2×2-dimensional matrix is. Therefore, the matrix generation unit 11 preferentially extracts two large non-diagonal elements included in the matrix B, and extracts these two diagonal elements, whereby it is possible to improve the accuracy of the calculation of the eigenvalue to be eventually obtained.

The eigenvalue decomposition unit 12 calculates the eigenvector that corresponds to the maximum eigenvalue of the matrix C, which is a 2×2-dimensional matrix generated by the matrix generation unit 11 (Step S14).

A method for calculating the eigenvector for the 2×2-dimensional matrix will be described. It is assumed here that the matrix A is a Hermitian matrix. In this case, the 2×2-dimensional matrix generated by the matrix generation unit 11 becomes a Hermitian matrix as well. The matrix C, which is a 2×2-dimensional matrix, can be defined as shown in the following Expression (1).

$$\begin{matrix}[ Expression 1 ] & \\ C = ( \begin{matrix}a & b \\ {b}^{*} & d\end{matrix} ) & ( 1 )\end{matrix}$$

Note that a and d are real numbers and b is a complex number. Further, the symbol * indicates a complex conjugate. In this case, the maximum eigenvalue λ of the matrix C and the eigenvector u that corresponds to this eigenvalue are calculated as shown in the following Expressions (2) and (3).

$$\begin{matrix}[ Expression 2 ] & \\ λ = \frac{a + d + \sqrt{{( a - d )}^{2} + 4 {\vert b \vert}^{2}}}{2} & ( 2 )\end{matrix}$$

$$\\ \begin{matrix}u = \frac{1}{\sqrt{{\vert b \vert}^{2} + {( λ - a )}^{2}}} ( \begin{matrix}b \\ λ - a\end{matrix} ) & ( 3 )\end{matrix}$$

The eigenvalue decomposition unit 12 calculates the eigenvector that corresponds to the maximum eigenvalue of the matrix C using the above Expressions (2) and (3). The eigenvalue decomposition unit 12 outputs the calculated two-dimensional eigenvector to the matrix dimension reduction unit 13. When two elements of the eigenvector u are denoted by elements u₁ and u₂, the elements u₁ and u₂ can be expressed as follows.

$$[ Expression 3 ]$$

$${u}_{1} = \frac{b}{\sqrt{{\vert b \vert}^{2} + {( λ - a )}^{2}}}$$

$${u}_{2} = \frac{λ - a}{\sqrt{{\vert b \vert}^{2} + {( λ - a )}^{2}}}$$

The matrix dimension reduction unit 13 reduces the dimension of the matrix B using the matrix B, the extracted element information, and the two-dimensional eigenvectors input from the eigenvalue decomposition unit 12, and generates a matrix D obtained by reducing the dimension of the matrix B (Step S15). The matrix dimension reduction unit 13 combines two rows and two columns of the matrix B that corresponds to the 2×2-dimensional matrix using the two-dimensional eigenvector calculated by the eigenvalue decomposition unit 12, and reduces the dimension of the matrix B. The matrix dimension reduction unit 13 outputs the extracted element information and the two-dimensional eigenvector to the eigenvector combination unit 14.

Here, an operation executed by the matrix dimension reduction unit 13 in Step S15 will be described using examples. Assume that the matrix B before the dimension is reduced is as follows.

$$[ Expression 4 ]$$

$$( \begin{matrix}{r}_{11} \\ {r}_{21} \\ {r}_{31} \\ {r}_{41}\end{matrix} \begin{matrix}{r}_{12} \\ {r}_{22} \\ {r}_{32} \\ {r}_{42}\end{matrix} \begin{matrix}{r}_{13} \\ {r}_{23} \\ {r}_{33} \\ {r}_{43}\end{matrix} \begin{matrix}{r}_{14} \\ {r}_{24} \\ {r}_{34} \\ {r}_{44}\end{matrix} )$$

It is assumed that the matrix generation unit 11 has extracted the element in the first row and the first column, the element in the first row and the second column, the element in the second row and the first column, and the element in the second row and the second column from the matrix B and generated a matrix C, which is a 2×2-dimensional matrix. It is further assumed that the eigenvalue decomposition unit 12 has calculated a two-dimensional eigenvector including two elements u₁ and u₂ using the aforementioned Expressions (2) and (3).

In this case, the matrix dimension reduction unit 13 multiplies each of the elements of the first column of the matrix B by the element u₁ and multiplies each of the elements of the second column of the matrix B by the element u₂. The matrix dimension reduction unit 13 adds the elements in the same row of the first column and the second column together, sets each of the elements that are added as each of the elements in the first new column, and deletes the second column, thereby generating a matrix B′ in which the first and second columns of the matrix B are composed. The matrix dimension reduction unit 13 composes the first and second columns of the matrix B, and generates a matrix B′

$$[ Expression 5 ]$$

$$( \begin{matrix}{u}_{1} {r}_{11} + {u}_{2} {r}_{12} \\ {u}_{1} {r}_{21} + {u}_{2} {r}_{22} \\ {u}_{1} {r}_{31} + {u}_{2} {r}_{32} \\ {u}_{1} {r}_{41} + {u}_{2} {r}_{42}\end{matrix} \begin{matrix}{r}_{13} \\ {r}_{23} \\ {r}_{33} \\ {r}_{43}\end{matrix} \begin{matrix}{r}_{14} \\ {r}_{24} \\ {r}_{34} \\ {r}_{44}\end{matrix} )$$

in which the first and second columns of the matrix B are composed. In other words, the matrix dimension reduction unit 13 composes the column vector in the first column and the column vector in the second column of the matrix B using the elements u₁ and u₂. The columns that are composed correspond to the positions of the elements that the matrix generation unit 11 has extracted from the matrix B. For example, when the matrix generation unit 11 has extracted the element in the second row and the second column, the element in the second row and the third column, the element in the third row and the second column, and the element in the third row and the third column from the matrix B, the matrix dimension reduction unit 13 composes the second and third columns of the matrix B.

Next, the matrix dimension reduction unit 13 multiplies each of the elements of the first row of the matrix B′ by the complex conjugate of the element u₁, and multiplies each of the elements of the second row by the complex conjugate of the element u₂. The matrix dimension reduction unit 13 adds elements in the same column of the first and second rows together, sets each of the elements that are added as each of the elements in the first new row, and deletes the second row, thereby composing the first and second rows of the matrix B′. The matrix dimension reduction unit 13 composes the first and second rows of the matrix B′ and generates a matrix

$$[ Expression 6 ]$$

$$( \begin{matrix}\begin{matrix}{u}_{1}^{*} ( {u}_{1} {r}_{11} + {u}_{2} {r}_{12} ) \\ + {u}_{2}^{*} ( {u}_{1} {r}_{21} + {u}_{2} {r}_{22} )\end{matrix} & {u}_{1}^{*} {r}_{13} + {u}_{2}^{*} {r}_{23} & {u}_{1}^{*} {r}_{14} + {u}_{2}^{*} {r}_{24} \\ {u}_{1} {r}_{31} + {u}_{2} {r}_{32} & {r}_{33} & {r}_{34} \\ {u}_{1} {r}_{41} + {u}_{2} {r}_{42} & {r}_{43} & {r}_{44}\end{matrix} )$$

in which the first and second rows of the matrix B′ are combined as a matrix D. In other words, the matrix dimension reduction unit 13 composes the row vector in the first row of the matrix B and the row vector in the second row of the matrix B using the complex conjugate of the element u₁ and the complex conjugate of the element u₂. Note that the matrix dimension reduction unit 13 may compose a column vector after the row vector of the matrix B is composed or may compose a row vector after the column vector is composed.

The aforementioned examples may be generalized as follows. It is assumed that the matrix generation unit 11 has extracted the element (i,i), the element (j,j), the element (i,j), and the element (j,i) from among the elements of the matrix B, and generated a matrix C, which is a 2×2-dimensional matrix. The symbols i and j are integers and have a relationship of i<j. It is further assumed that the eigenvalue decomposition unit 12 has calculated a two-dimensional eigenvector u including the element u₁ and the element u₂.

In this case, the matrix dimension reduction unit 13 multiplies each of the elements included in the i-th column vector of the matrix B by the element u₁ and multiplies each of the elements included in the j-th column vector of the matrix B by the element u₂. The matrix dimension reduction unit 13 adds the element in the p (p: a natural number to the number of dimensions before the dimension of the matrix B is reduced)-th row included in the i-th column vector and the element in the p-th row included in the j-th column vector. The matrix dimension reduction unit 13 performs addition of the element in the p-th row included in the i-th column vector and the element in the p-th row included in the j-th column vector for all the rows of the matrix B.

The matrix dimension reduction unit 13 updates the i-th column vector in such a way that the respective values after the addition become the values of the respective elements of the i-th new column vector of the matrix B, deletes the j-th column vector of the matrix B, and reduces the number of columns of the matrix B. Note that the matrix dimension reduction unit 13 may update the j-th column vector in such a way that the respective values after the addition are the values of the respective elements of the j-th new column vector of the matrix B, delete the i-th column vector of the matrix B, and reduce the number of columns of the matrix B.

The matrix dimension reduction unit 13 multiplies each of the elements included in the i-th row vector of the matrix B′ after the i-th column vector and the j-th column vector of the matrix B are composed by the complex conjugate of the element u₁ and multiplies each of the elements included in the j-th row vector of the matrix B′ by the complex conjugate of the element u₂. The matrix dimension reduction unit 13 adds the element in the p-th column included in the i-th row vector of the matrix B′ and the element in the p-th column included in the j-th row vector. The matrix dimension reduction unit 13 performs addition of the element in the p-th column included in the i-th row vector and the element in the p-th column included in the j-th row vector for all the columns of the matrix B.

The matrix dimension reduction unit 13 updates the i-th row vector in such a way that the respective values after the addition become the values of the respective elements of the i-th new row vector of the matrix B′, deletes the j-th row vector of the matrix B′, and reduces the number of rows of the matrix B′. The matrix dimension reduction unit 13 generates the matrix obtained by reducing the number of rows of the matrix B′ as a matrix D. That is, the matrix dimension reduction unit 13 composes the i-th column vector, the j-th column vector, the i-th row vector, and the j-th column vector of the matrix B, and generates a matrix obtained by reducing the number of columns and the number of rows of the matrix B as a matrix D. Note that the matrix dimension reduction unit 13 may update the j-th row vector in such a way that the respective values after the addition become the values of the respective elements of the j-th new row vector of the matrix B′, delete the i-th row vector of the matrix B′, and reduce the number of rows of the matrix B′. In this way, the matrix dimension reduction unit 13 composes two columns and two rows of the matrix B and reduces each of the number of columns and the number of rows of the matrix B by one, thereby reducing the dimension of the matrix B.

Referring once again to FIG. 5, the explanation will be continued. The matrix dimension reduction unit 13 determines whether the number of elements included in the matrix D is one (Step S16).

When the dimension of the matrix D is equal to or larger than the 2×2 dimension and the matrix D includes a plurality of elements (NO in Step S16), the matrix dimension reduction unit 13 updates the matrix B based on the matrix D (Step S17). The matrix dimension reduction unit 13 updates the matrix B in such a way that the matrix D becomes a new matrix B. After the eigenvalue decomposition apparatus 10 executes Step S17, it executes Step S13 and the following steps.

On the other hand, when the dimension of the matrix D is 1×1 dimension and the number of elements included in the matrix D is one (YES in Step S16), the matrix dimension reduction unit 13 determines the element included in the matrix D as the eigenvalue of the matrix A (Step S18). The matrix dimension reduction unit 13 outputs the determined eigenvalue to the eigenvector combination unit 14.

The eigenvector combination unit 14 combines a plurality of two-dimensional eigenvectors calculated by the eigenvalue decomposition unit 12 before the number of elements included in the matrix D becomes one and calculates the eigenvector of the matrix A (Step S19).

Now, an operation executed by the eigenvector combination unit 14 in Step S19 will be described using an example. It is assumed that the matrix A is a 4×4-dimensional matrix. It is further assumed that the eigenvalue decomposition unit 12 has calculated three two-dimensional eigenvectors u⁽⁰⁾, u⁽¹⁾, u⁽²⁾ until when the number of elements included in the matrix B becomes one using the element (1,1), the element (2,2), the element (1,2), and the element (2,1) of the matrix B. It is assumed that the two elements of the two-dimensional eigenvector u⁽⁰⁾ are

u₁⁽⁰⁾,u₂⁽⁰⁾ [Expression 7]

and the two elements of the two-dimensional eigenvector u⁽¹⁾ are

u₁⁽¹⁾,u₂⁽¹⁾ [Expression 8]

and the two elements of the two-dimensional eigenvector u⁽²⁾ are as follows.

u₁⁽²⁾,u₂⁽²⁾ [Expression 9]

First, the eigenvector combination unit 14 generates a 4×4-dimensional unit matrix

$$[ Expression 10 ]$$

$$( \begin{matrix}1 & 0 & 0 & 0 \\ 0 & 1 & 0 & 0 \\ 0 & 0 & 1 & 0 \\ 0 & 0 & 0 & 1\end{matrix} )$$

whose dimension is the same as that of the matrix A and sets this generated unit matrix as the initial matrix of the matrix E. Next, the eigenvector combination unit 14 multiplies, using the two elements

u₁⁽⁰⁾,u₂⁽⁰⁾ [Expression 11]

of the two-dimensional eigenvector u⁽⁰⁾, each element in the first column of the unit matrix E by the first element u₁ of the aforementioned two-dimensional eigenvector and multiplies each element in the second column by the second element u₂ of the aforementioned two-dimensional eigenvector. The eigenvector combination unit 14 adds the elements in the same row of the first column and the second column together, sets each of the added elements as each element of the first new column, and deletes the second column, thereby combining the first column and the second column of the matrix E. The eigenvector combination unit 14 combines the first column and the second column of the matrix E using the first two-dimensional eigenvector, generates a matrix

$$[ Expression 12 ]$$

$$( \begin{matrix}{u}_{1}^{( 0 )} \times 1 + {u}_{2}^{( 0 )} \times 0 & 0 & 0 \\ {u}_{1}^{( 0 )} \times 0 + {u}_{2}^{( 0 )} \times 1 & 0 & 0 \\ {u}_{1}^{( 0 )} \times 0 + {u}_{2}^{( 0 )} \times 0 & 1 & 0 \\ {u}_{1}^{( 0 )} \times 0 + {u}_{2}^{( 0 )} \times 0 & 0 & 1\end{matrix} ) = ( \begin{matrix}{u}_{1}^{( 0 )} & 0 & 0 \\ {u}_{2}^{( 0 )} & 0 & 0 \\ 0 & 1 & 0 \\ 0 & 0 & 1\end{matrix} )$$

in which the first column and the second column are combined with each other, and sets the generated matrix as a new matrix E. Note that the columns to be combined with each other correspond to the positions of the elements of the matrix B used in the two-dimensional eigenvectors calculated by the eigenvalue decomposition unit 12.

The eigenvector combination unit 14 combines the first and second columns in a way similar to that described above using two elements

u₁⁽¹⁾,u₂⁽¹⁾ [Expression 13]

of the second two-dimensional eigenvector u⁽¹⁾, the first and second columns for the matrix E generated using the first two-dimensional eigenvector. The eigenvector combination unit 14 combines, using the second two-dimensional eigenvector, the first column and the second column of the matrix E, generates a matrix

$$[ Expression 14 ]$$

$$( \begin{matrix}{u}_{1}^{( 1 )} \times {u}_{1}^{( 0 )} + {u}_{2}^{( 1 )} \times 0 & 0 \\ {u}_{1}^{( 1 )} \times {u}_{2}^{( 0 )} + {u}_{2}^{( 1 )} \times 0 & 0 \\ {u}_{1}^{( 1 )} \times 0 + {u}_{2}^{( 1 )} \times 1 & 0 \\ {u}_{1}^{( 1 )} \times 0 + {u}_{2}^{( 1 )} \times 0 & 1\end{matrix} ) = ( \begin{matrix}{u}_{1}^{( 1 )} {u}_{1}^{( 0 )} & 0 \\ {u}_{1}^{( 1 )} {u}_{2}^{( 0 )} & 0 \\ {u}_{2}^{( 1 )} & 0 \\ 0 & 1\end{matrix} )$$

and sets the generated matrix as a new matrix E.

The eigenvector combination unit 14 combines the first column and the second column of the matrix E in a way similar to that stated above using two elements

u₁⁽²⁾,u₂⁽²⁾ [Expression 15]

of the third two-dimensional eigenvector u⁽²⁾ for the matrix E generated using the second two-dimensional eigenvector. The eigenvector combination unit 14 combines the first column and the second column of the matrix E using the third two-dimensional eigenvector, generates a matrix

$$[ Expression 16 ]$$

$$( \begin{matrix}{u}_{1}^{( 2 )} \times {u}_{1}^{( 1 )} {u}_{1}^{( 0 )} + {u}_{2}^{( 2 )} \times 0 \\ {u}_{1}^{( 2 )} \times {u}_{1}^{( 1 )} {u}_{2}^{( 0 )} + {u}_{2}^{( 2 )} \times 0 \\ {u}_{1}^{( 2 )} \times {u}_{2}^{( 1 )} + {u}_{2}^{( 2 )} \times 0 \\ {u}_{1}^{( 2 )} \times 0 + {u}_{2}^{( 2 )} \times 1\end{matrix} ) = ( \begin{matrix}{u}_{1}^{( 2 )} {u}_{1}^{( 1 )} {u}_{1}^{( 0 )} \\ {u}_{1}^{( 2 )} {u}_{1}^{( 1 )} {u}_{2}^{( 0 )} \\ {u}_{1}^{( 2 )} {u}_{2}^{( 1 )} \\ {u}_{2}^{( 2 )}\end{matrix} )$$

and sets the generated matrix as a new matrix E. When the matrix E includes only one column vector, the eigenvector combination unit 14 determines the matrix E to be the eigenvector of the matrix A. In this way, the eigenvector combination unit 14 combines all the two-dimensional eigenvectors calculated before the number of elements included in the matrix B becomes one and determines the eigenvector of the matrix A.

The aforementioned examples may be generalized as follows. The eigenvector combination unit 14 generates a unit matrix whose dimension is the same as that of the matrix A and sets the generated unit matrix as the initial matrix of the matrix E. The eigenvector combination unit 14 repeats weighted composition of the column vector of the matrix E and the reduction in the number of columns using a plurality of two-dimensional eigenvectors calculated by the eigenvalue decomposition unit 12 and calculates the eigenvector of the matrix A. The eigenvector combination unit 14 performs weighted composition of the column vector of the matrix E in an order in which the eigenvalue decomposition unit 12 has calculated the two-dimensional eigenvectors.

The combination of two-dimensional eigenvectors can be specifically described as follows. It is assumed that the two-dimensional eigenvectors calculated by the eigenvalue decomposition unit 12 have been calculated from the element (i,i), the element (j,j), the element (i,j), and the element (j,i) of the matrix B. It is assumed that i and j are both integers and i<j is satisfied. It is further assumed that the eigenvalue decomposition unit 12 has calculated a two-dimensional eigenvector including the elements u₁ and u₂. In this case, the eigenvector combination unit 14 multiplies each element included in the i-th column vector of the matrix E by the element u₁ and multiplies each element included in the j-th column vector by the element u₂. The eigenvector combination unit 14 adds the element in the q (q: a natural number to the number of dimensions of the matrix E)-th row included in the i-th column vector and the element in the q-th row included in the j-th column vector. The eigenvector combination unit 14 performs addition of the element in the q-th row included in the i-th column vector and the element in the q-th row included in the j-th column vector for all the rows in the matrix E.

The eigenvector combination unit 14 updates the i-th column vector in such a way that the respective values after the addition become the values of the respective elements of the i-th new column vector of the matrix E, deletes the j-th column vector of the matrix E, reduces the number of columns of the matrix E, and generates a new matrix E in which the two-dimensional eigenvectors are combined. The eigenvector combination unit 14 performs the aforementioned operation on all the two-dimensional eigenvectors calculated before the number of elements included in the matrix D becomes one in the order in which the eigenvalue decomposition unit 12 has calculated the two-dimensional eigenvectors. The eigenvector combination unit 14 determines, when the element of the matrix E has become only one column vector, the matrix E to be the eigenvector of the matrix A. Note that the eigenvector combination unit 14 may set the column vector after the addition as a j-th new column vector of the matrix E, delete the i-th column vector of the matrix E, reduce the number of columns of the matrix E, and generate a new matrix E.

Referring once again to FIG. 5, the explanation will be continued. The eigenvector combination unit 14 determines whether the number of eigenvalues of the matrix A and the number of eigenvectors of the matrix A are a predetermined number (Step S20).

When the number of eigenvalues of the matrix A and the number of eigenvectors of the matrix A are smaller than the predetermined number (NO in Step S20), the removal unit 15 removes the component that corresponds to the eigenvalue of the matrix A from the matrix A (Step S21). The removal unit 15 removes the component that corresponds to the input eigenvalue from the matrix A using the matrix A input from the matrix generation unit 11, and the eigenvalue of the matrix A and the eigenvector of the matrix A input from the eigenvector combination unit 14.

The k (k: an integer equal to or larger than one but is equal to or smaller than a predetermined number)-th eigenvalue of the matrix A, which has been calculated in Step S18, is denoted by λₖ. Further, the k-th eigenvector of the matrix A, which has been calculated in Step S19, is denoted by vₖ. In this case, in Step S21, the removal unit 15 removes the component of the k-th eigenvalue of the matrix A from the matrix A by Expression (4).

A=A−λₖvₖvₖ^{H} (4)

Note that ^{H} denotes a Hermitian transpose.

The removal unit 15 updates the matrix A based on the matrix A from which the eigenvalue component has been removed (Step S22). The removal unit 15 updates the matrix A in such a way that the matrix A from which the eigenvalue component has been removed becomes a new matrix A using Expression (4). The removal unit 15 outputs the matrix A after the update to the matrix generation unit 11. After the eigenvalue decomposition apparatus 10 executes Step S22, it executes the operations in Step S12 and the following steps. In this way, the eigenvalue decomposition apparatus 10 is able to remove the component that corresponds to the eigenvalue determined from the matrix A and obtain the eigenvalue of the matrix A, which is the second largest eigenvalue after the eigenvalue removed from the matrix A, and the eigenvector of the matrix A that corresponds to the eigenvalue of the matrix A.

When the number of eigenvalues of the matrix A and the number of eigenvectors of the matrix A are the predetermined number (YES in Step S20), the eigenvector combination unit 14 outputs the eigenvalue of the matrix A and the eigenvector of the matrix A to the input/output apparatus 50 (Step S23).

As described above, the eigenvalue decomposition apparatus 10 obtains the eigenvalue of the matrix A and the eigenvector of the matrix A by repeating the calculation of the two-dimensional eigenvector for the 2×2-dimensional matrix included in the matrix on which eigenvalue decomposition is to be performed and reduction in the dimension of the matrix using the calculated two-dimensional eigenvector. The eigenvalue decomposition apparatus 10 further obtains a plurality of eigenvalues and eigenvectors for the matrix A by repeating processing similar to that stated above on the matrix in which the component of the eigenvalue that has been calculated has been removed from the matrix A. The eigenvalue decomposition apparatus 1 reduces the dimension of the matrix B by combining two column vectors and two row vectors of the matrix B using the calculated two-dimensional eigenvector.

While the eigenvalue to be eventually determined is an approximate solution, the eigenvalue decomposition apparatus 10 is able to calculate the eigenvalue and the eigenvector of the matrix A with a smaller amount of computation by the eigenvalue decomposition of the 2×2-dimensional matrix and the linear combination of vectors. That is, the eigenvalue decomposition apparatus 1 is able to calculate the eigenvalue and the eigenvector of the matrix A by performing the eigenvalue decomposition of the 2×2-dimensional matrix and the linear combination of the vectors which require a small amount of computation instead of performing computation such as a product of a matrix and a vector and matrix multiplication which require a large amount of computation. Accordingly, with the eigenvalue decomposition apparatus 10 according to the second example embodiment, it is possible to reduce the amount of computation required for the eigenvalue decomposition and perform eigenvalue decomposition at a high speed. Further, since the eigenvalue decomposition apparatus 10 according to the second example embodiment includes the removal unit 15, the eigenvalue decomposition apparatus 10 is able to determine a predetermined number of eigenvalues in an order from the largest the eigenvalue.

### Modified Example 1

While the matrix generation unit 11 has generated one matrix C in the second example embodiment, the matrix generation unit 11 may concurrently generate a plurality of matrices C, which are 2×2-dimensional matrices. Then, the eigenvalue decomposition unit 12 may calculate two-dimensional eigenvectors for the plurality of matrices C generated by the matrix generation unit 11 in parallel to each other, and the matrix dimension reduction unit 13 may reduce the two or more rows and columns of the matrix B at the same time. In this case, the matrix generation unit 11 generates a plurality of 2×2-dimensional matrices in such a way that one element included in the matrix B is not extracted as elements of a plurality of 2×2-dimensional matrices at the same time.

As described above, even when the second example embodiment is modified as shown in Modified Example 1, the effect similar to that obtained in the second example embodiment may be obtained. Further, by configuring the second example embodiment as shown in Modified Example 1, the eigenvalue decomposition apparatus 10 is able to further increase the speed of the calculation of the eigenvalue of the matrix A and the eigenvector of the matrix A compared to that in the second example embodiment. That is, by forming the eigenvalue decomposition apparatus 10 according to the second example embodiment as described in Modified Example 1, the eigenvalue decomposition may be performed at a speed higher than that in the second example embodiment.

### Modified Example 2

While the matrix generation unit 11 has extracted two diagonal elements and two non-diagonal elements included in the matrix B in the second example embodiment, the matrix generation unit 11 may extract, from the matrix B, elements included in the row vector in the i-th row and elements included in the row vector in the j-th row, and generate a matrix C based on the extracted elements. Alternatively, the matrix generation unit 11 may extract, from the matrix B, elements included in the column vector in the i-th column and elements included in the column vector in the j-th column, and generate the matrix C based on the extracted elements.

When, for example, the matrix generation unit 11 extracts the column vector in the i-th column and the column vector in the j-th column from the matrix B, the matrix generation unit 11 may select two column vectors at random and determine the elements to be extracted. Alternatively, the matrix generation unit 11 may determine the elements to be extracted by selecting, of the matrix B, a non-diagonal element rᵢⱼ having a large absolute value, and extracting the column vectors in the i-th column and the j-th column. Alternatively, the matrix generation unit 11 may determine the elements to be extracted by selecting two vectors having large absolute values of rᵢHᵣ_{ⱼ} indicating the correlation between the column vector in the i-th column and the column vector in the j-th column. In a case in which the matrix generation unit 11 extracts two row vectors from the matrix B as well, the matrix generation unit 11 may determine the elements to be extracted in a way similar to that stated above.

It is assumed that the matrix generation unit 11 has selected, for example, two column vectors rᵢ and rⱼ from the matrix B. In this case, the matrix generation unit 11 may set the matrix C, which is a 2×2-dimensional matrix, as follows.

$$[ Expression 18 ]$$

$${C}_{2 \times 2} = ( \begin{matrix}{‖ {r}_{i} ‖}^{2} & {r}_{i}^{H} {r}_{j} \\ {r}_{j}^{H} {r}_{i} & {‖ {r}_{j} ‖}^{2}\end{matrix} )$$

Even when the second example embodiment is modified in this manner, the effect similar to that obtained in the second example embodiment may be obtained.

### Third Example Embodiment

Next, a third example embodiment will be described. The third example embodiment is a modified example of the second example embodiment. In the third example embodiment, the eigenvalue decomposition apparatus performs calculation by a power method using the eigenvector output from the eigenvector combination unit as an initial vector, and updates the eigenvalue of the matrix A and the eigenvector of the matrix A.

### Configuration Example of Information Processing System

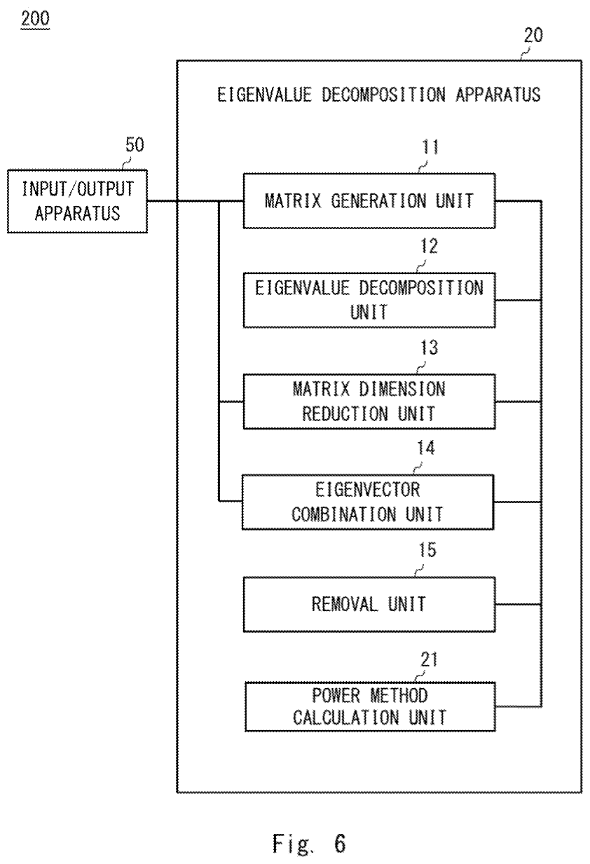

With reference to FIG. 6, a configuration example of an information processing system 200 according to the third example embodiment will be described. FIG. 6 is a diagram showing a configuration example of the information processing system according to the third example embodiment. The information processing system 200 includes an input/output apparatus 50 and an eigenvalue decomposition apparatus 20. The information processing system 200 has a configuration in which the eigenvalue decomposition apparatus 10 according to the second example embodiment is replaced by the eigenvalue decomposition apparatus 20. Since the configuration example and the operation example of the input/output apparatus 50 are similar to those in the second example embodiment, the descriptions thereof will be omitted.

### Configuration Example of Eigenvalue Decomposition Apparatus

Next, a configuration example of the eigenvalue decomposition apparatus 20 will be described. The eigenvalue decomposition apparatus 20 includes a matrix generation unit 11, an eigenvalue decomposition unit 12, a matrix dimension reduction unit 13, an eigenvector combination unit 14, a removal unit 15, and a power method calculation unit 21. In the eigenvalue decomposition apparatus 20, a power method calculation unit 21 is added to the components of the eigenvalue decomposition apparatus 10 according to the second example embodiment.

Since the matrix generation unit 11, the eigenvalue decomposition unit 12, the matrix dimension reduction unit 13, the eigenvector combination unit 14, and the removal unit 15 are basically similar to those in the second example embodiment, the descriptions thereof will be omitted as appropriate, and the points different from those in the second example embodiment will be described.

Although the eigenvector combination unit 14 is basically similar to that in the second example embodiment, the eigenvector combination unit 14 outputs the calculated eigenvector of the matrix A to the power method calculation unit 21, unlike the second example embodiment. Further, unlike the eigenvector combination unit according to the second example embodiment, the eigenvector combination unit 14 does not make a determination regarding whether the number of eigenvalues of the matrix A and the number of eigenvectors of the matrix A are the predetermined number and does not output the eigenvalue and the eigenvector of the matrix A to the input/output apparatus 50.

Although the removal unit 15 is basically similar to that in the second example embodiment, the removal unit 15 acquires (receives) the eigenvalue of the matrix A and the eigenvector of the matrix A from the power method calculation unit 21, unlike the removal unit 15 in the second example embodiment. Further, the removal unit 15 outputs the matrix A received from the matrix generation unit 11 to the power method calculation unit 21. The matrix A input to the power method calculation unit 21 is a matrix A that the matrix generation unit 11 has acquired from the input/output apparatus 50 or a matrix A in which the removal unit 15 has removed the component that corresponds to the eigenvalue.

The power method calculation unit 21 performs calculation by a power method on the matrix A using the eigenvector of the matrix A as an initial vector, and updates the eigenvalue and the eigenvector of the matrix A. Since the power method calculation unit 21 updates the eigenvalue and the eigenvector of the matrix A, the power method calculation unit 21 may be referred to as a second update unit.

The power method calculation unit 21 acquires the matrix A from the removal unit 15. The power method calculation unit 21 acquires the eigenvector of the matrix A from the eigenvector combination unit 14. The power method calculation unit 21 calculates the eigenvalue and the eigenvector of the matrix A by a power method using the acquired matrix A and the eigenvector of the acquired matrix A.

The power method calculation unit 21 determines whether the number of eigenvalues of the matrix A and the number of eigenvectors of the matrix A are a predetermined number. When the number of eigenvalues of the matrix A and the number of eigenvectors of the matrix A have reached the predetermined number, the power method calculation unit 21 outputs the eigenvalue of the matrix A and the eigenvector of the matrix A to the input/output apparatus 50.

The eigenvector combination unit 14 may determine whether or not the number of eigenvalues of the matrix A and the number of eigenvectors of the matrix A are the predetermined number. When the number of eigenvalues of the matrix A and the number of eigenvectors of the matrix A have reached the predetermined number, the power method calculation unit 21 may output the eigenvalue of the matrix A and the eigenvector of the matrix A to the eigenvector combination unit 14. Then, the eigenvector combination unit 14 may output the eigenvalue of the matrix A and the eigenvector of the matrix A to the input/output apparatus 50.

### Operation Example of Eigenvalue Decomposition Apparatus

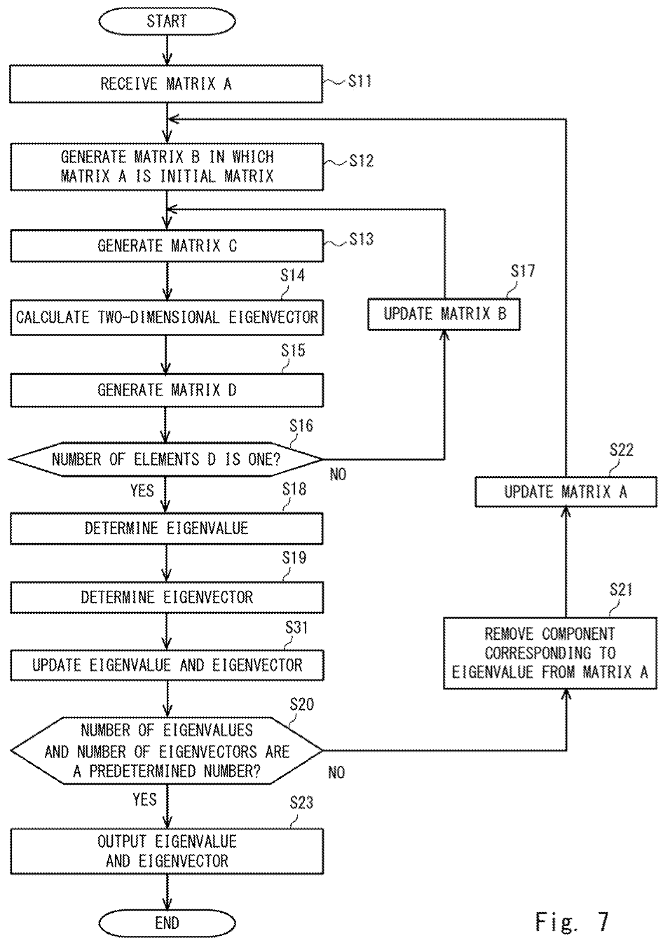

Referring next to FIG. 7, an operation example of the eigenvalue decomposition apparatus 20 will be described. FIG. 7 is a flowchart showing the operation example of the eigenvalue decomposition apparatus according to the third example embodiment. FIG. 7, which corresponds to FIG. 5, is a diagram in which Step S31 is added to the flowchart shown in FIG. 5. Since Steps S11-S23 are basically similar to those in the second example embodiment shown in FIG. 5, the descriptions thereof will be omitted as appropriate.

In Step S31, the power method calculation unit 21 performs calculation on the matrix A by a power method using the eigenvector of the matrix A as an initial vector, and updates the eigenvalue and the eigenvector of the matrix A (Step S31).

The power method calculation unit 21 acquires the matrix A from the removal unit 15. This matrix A is the matrix A input from the input/output apparatus 50, or a matrix A in which the removal unit 15 has removed the component that corresponds to the eigenvalue. The power method calculation unit 21 acquires the eigenvector of the matrix A from the eigenvector combination unit 14. The power method calculation unit 21 calculates an eigenvalue and an eigenvector of the matrix A by a power method using the acquired matrix A and the eigenvector of the acquired matrix A.

An operation of calculating the eigenvalue and the eigenvector of the matrix A executed by the power method calculation unit 21 in Step S31 will be described. The power method is a method for repeatedly multiplying an appropriate initial vector by the matrix A and thus obtaining the maximum eigenvalue of the matrix A and the eigenvector that corresponds to the matrix A. When the matrix A is a matrix in which the first eigenvalue component to the (k−1)-th eigenvalue component of the matrix A have been removed, the power method calculation unit 21 is able to calculate the k-th eigenvalue and the k-th eigenvector of the matrix A by using a power method.

In the following description, a case in which the power method calculation unit 21 calculates the k-th eigenvalue of the matrix A and the k-th eigenvector of the matrix A will be described. In this case, the power method calculation unit 21 receives (acquires) the k-th eigenvector of the matrix A from the eigenvector combination unit 14 and receives (acquires), from the removal unit 15, a matrix A in which the first eigenvalue component to the (k−1)-th eigenvalue component have been removed.

First, the power method calculation unit 21 sets the k-th eigenvector of the matrix A acquired from the eigenvector combination unit 14 as an initial vector x⁰). Then, the power method calculation unit 21 updates x^{(m)} and r^{(m)} from m=0 to m=M−1 in order by the following Expressions (5)-(7).

[Expression 19]

x^{(m+1)}=Ax^{(m)} (5)

r^{(m+1)}=∥x^{(m+1)}∥ (6)

x^{(m+1)}=x^{(m+1)}/r^{(m+1)} (7)

Then, the power method calculation unit 21 sets r^{(M)} and x^{(M)} obtained by the calculation when m=M−1 to be the k-th eigenvalue λₖ and the k-th eigenvector vₖ of the matrix A. The symbol “/” in Expression (7) indicates division.

While the case in which the power method calculation unit 21 performs calculation in Expressions (5)-(7) M times has been described as an example, the power method calculation unit 21 may end the calculation of the power method before m=M−1 in accordance with the degree of convergence of the value of r^{(m)}. The power method calculation unit 21 may set, for example, a ratio of the absolute value of (r^{(m+1)}−r^{(m)} to the absolute value of r^{(m)} as the degree of convergence and may end the calculation of the power method when the degree of convergence is smaller than a predetermined value. In this way, by ending the calculation in the power method when the degree of convergence is smaller than the predetermined value based on the degree of convergence, it is possible to reduce the amount of computation.

As described above, the eigenvalue decomposition apparatus 20 includes a configuration similar to that of the eigenvalue decomposition apparatus 10 according to the second example embodiment. Accordingly, with the eigenvalue decomposition apparatus 20 according to the third example embodiment, the effect similar to that obtained in the second example embodiment may be obtained.

Further, the eigenvalue decomposition apparatus 20 performs a power method using the eigenvector of the matrix A calculated by the eigenvector combination unit 14 as an initial value, calculates the eigenvalue of the matrix A and the eigenvector of the matrix A, and updates the eigenvalue of the matrix A and the eigenvector of the matrix A. In this way, the eigenvalue decomposition apparatus 20 performs calculation by a power method and updates the eigenvalue of the matrix A and the eigenvector of the matrix A. Therefore, it is possible to improve the accuracy of the calculation of the eigenvalue and the eigenvector compared to that in the second example embodiment. Since the eigenvalue decomposition apparatus 20 performs the power method in the third example embodiment, the amount of computation in the third example embodiment is larger than that in the second example embodiment. However, the eigenvalue decomposition apparatus 20 sets the eigenvector of the matrix A calculated by the eigenvector combination unit 14 as the initial value of the power method, whereby it is possible to reduce the number of iterations of the power method that is required to obtain a predetermined accuracy of the calculation compared to a general power method in which an appropriate value such as a random number is used as an initial value.

### Fourth Example Embodiment

Next, a fourth example embodiment will be described. In the second and third example embodiments, the information processing system using the eigenvalue decomposition apparatus has been described. In the fourth example embodiment, a radio communication system using the eigenvalue decomposition apparatus described in the second and third example embodiments will be described.

First, prior to giving the description of the details of this example embodiment, an overview of this example embodiment will be described.

In the radio communication system, beamforming transmission in which a radio communication apparatus on the transmitter side including a plurality of antennas adjusts the amplitude and the phase of the signal transmitted from each of the antennas to enhance or suppress signals in a specific direction is used. One transmission method of the beamforming transmission method includes eigenmode transmission. In the eigenmode transmission, the radio communication apparatus uses a singular vector of the channel matrix between the radio communication apparatus and the radio terminal on the receiver side as a weight coefficient multiplied by a signal transmitted from each of the antennas. The singular vector of the channel matrix is obtained by singular value decomposition of the channel matrix, or eigenvalue decomposition of the product of the Hermitian transpose of the channel matrix and the channel matrix.

In the radio communication system, it is required to calculate, for example, a weight coefficient multiplied by the transmission signal of each antenna within a short period of time in a unit of msec (milliseconds). That is, in the radio communication system, the radio communication apparatus needs to complete eigenvalue decomposition within a short time (in a unit of msec), determine a singular vector of a channel matrix between the radio communication apparatus and the radio terminal, and determine the weight coefficient used for eigenmode transmission. Therefore, if the radio communication apparatus conducts eigenvalue decomposition using a general eigenvalue decomposition method such as a power method or the Jacobi method or the eigenvalue decomposition method disclosed in Patent Literature 1 which requires a large amount of computation, it is possible that a weight coefficient may not be determined within the time required in the radio communication system. In this example embodiment, by applying the eigenvalue decomposition apparatus described in the second and third example embodiments to the radio communication apparatus, it is possible to determine the weight coefficient used for eigenmode transmission within the time required in the radio communication system.

Hereinafter, details of the fourth example embodiment will be described. While a radio communication system that uses the eigenvalue decomposition apparatus 10 according to the second example embodiment will be described as an example in the following description, the eigenvalue decomposition apparatus 20 according to the third example embodiment may be used in this example embodiment.

### Configuration Example of Radio Communication System

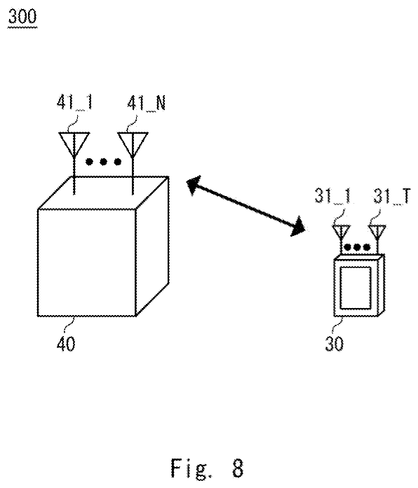

Referring to FIG. 8, a configuration example of the radio communication system 300 according to the fourth example embodiment will be described. FIG. 8 is a diagram showing a configuration example of the radio communication system according to the fourth example embodiment. The radio communication system 300 includes a radio terminal 30 and a radio communication apparatus 40. While the following description is given on the assumption that the radio communication system 300 includes one radio terminal 30, the radio communication system 300 may naturally include a plurality of radio terminals.

The radio terminal 30 may be, for example, a mobile station, a User Equipment (UE), a Wireless Transmit/Receive Unit (WTRU), or a relay apparatus having a relay function. The radio terminal 30 includes antennas 31_1 to 31_T (T: an integer equal to or larger than two). The radio terminal 30 connects to and communicates with the radio communication apparatus 40 via the antennas 31_1 to 31_T. The radio terminal 30 transmits a radio signal including a reference signal that the radio communication apparatus 40 uses to calculate the estimated value of the channel response to the radio communication apparatus 40. Note that in the following description, when the antennas 31_1 to 31_T are not distinguished from each other, they may be simply referred to as “antenna(s) 31”.

The radio communication apparatus 40 may be, for example, a base station or an access point. The radio communication apparatus 40 may be NR NodeB (NR NB) or gNodeB (gNB). Alternatively, the radio communication apparatus 40 may be eNodeB (evolved Node B or eNB).

The radio communication apparatus 40 includes antennas 41_1 to 41_N (N: an integer equal to or larger than two). The radio communication apparatus 40 connects to and communicates with the radio terminal 30 via each of the antennas 41_1 to 41_N. The radio communication apparatus 40 corresponds to the eigenmode transmission. Note that in the following description, when the antennas 41_1 to 41_N are not distinguished from each other, they may be simply referred to as “antenna(s) 41”.

### Configuration Example of Radio Communication Apparatus

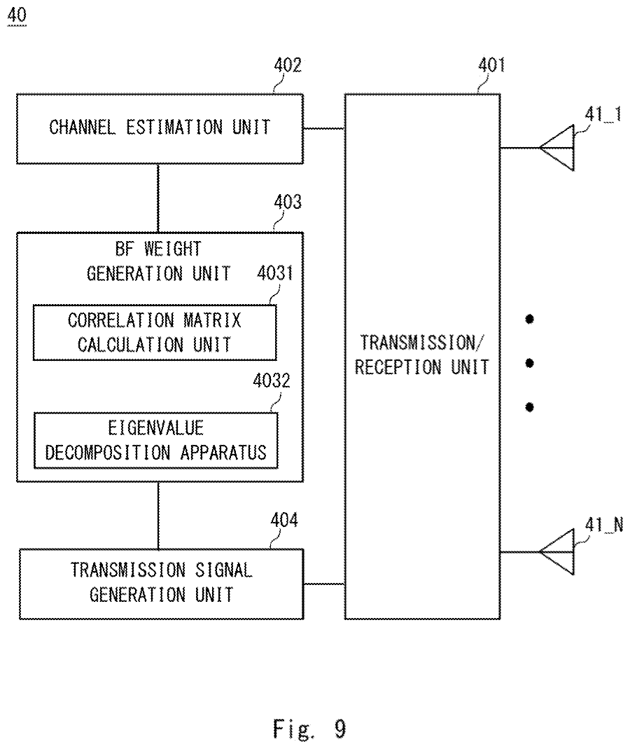

With reference to FIG. 9, a configuration example of the radio communication apparatus 40 will be described. FIG. 9 is a diagram showing a configuration example of the radio communication apparatus according to the fourth example embodiment. The radio communication apparatus 40 includes antennas 41_1 to 41_N (antenna 41), a transmission/reception unit 401, a channel estimation unit 402, a BeamForming (BF) weight generation unit 403, and a transmission signal generation unit 404.

The antenna 41 receives a radio signal including a reference signal transmitted from the radio terminal 30 and outputs the received radio signal to the transmission/reception unit 401. It is assumed that the reference signal transmitted by the radio terminal 30 is known in the radio communication apparatus 40. Further, the antenna 41 transmits the radio signal input from the transmission/reception unit 401 to the radio terminal 30.

The transmission/reception unit 401 converts the radio signal input from the antenna 41 into a baseband signal and outputs this baseband signal to the channel estimation unit 402. Further, the transmission/reception unit 401 converts the baseband signal input from the transmission signal generation unit 404 into a radio signal and outputs this radio signal to the antenna 41.

Depending on the radio communication method used in the radio communication system 300, it may be necessary to perform processing such as removal of Cyclic Prefix (CP), a Fast Fourier Transform (FFT) and the like between the transmission/reception unit 401 and the channel estimation unit 402. Therefore, a module that performs the above-described processing may be provided between the transmission/reception unit 401 and the channel estimation unit 402. Note that, since the above-described module is not directly related to the present disclosure, the illustration and description of the module that performs the above-described processing are omitted in this specification.

The channel estimation unit 402 calculates an estimated value of the channel response between each of the antennas 41_1 to 41_N of the radio communication apparatus 40 and each of the antennas 31_1 to 31_T of the radio terminal 30 using the reference signal input from the transmission/reception unit 401. The channel estimation unit 402 may estimate, as the channel response, a frequency response of the channel or an impulse response of the channel.

The channel estimation unit 402 generates a channel matrix H having the estimation values of the channel response that have been calculated as the respective elements. The number of antennas 41 of the radio communication apparatus 40 is N and the number of antennas 31 of the radio terminal 30 is T. Therefore, the channel estimation unit 402 generates a T×N-dimensional channel matrix H. The channel estimation unit 402 outputs the channel matrix H to the BF weight generation unit 403.

The BF weight generation unit 403 receives the channel matrix H, determines a weight coefficient W multiplied by the radio signal to be transmitted to the radio terminal 30, and outputs the weight coefficient W to the transmission signal generation unit 404. The BF weight generation unit 403 includes a correlation matrix calculation unit 4031 and an eigenvalue decomposition apparatus 4032.

The correlation matrix calculation unit 4031 receives the channel matrix H from the channel estimation unit 402, calculates a product of the Hermitian transpose of the channel matrix H and the channel matrix H, and calculates a channel correlation matrix R. The channel correlation matrix R may be expressed as shown in Expression (8).

[Expression 20]

R=H^{H}H (8)

Note that the superscript H denotes a Hermitian transpose.

The correlation matrix calculation unit 4031 outputs the calculated channel correlation matrix R to the eigenvalue decomposition apparatus 4032. While it will be described later, since the eigenvalue decomposition apparatus 4032 receives the channel correlation matrix R as a matrix A, it can be said that the correlation matrix calculation unit 4031 calculates the matrix A using the channel matrix.

In the eigenvalue decomposition apparatus 4032, the eigenvalue decomposition apparatus 10 according to the second example embodiment functions as channel correlation matrix eigenvalue decomposition means. Since the configuration example of the eigenvalue decomposition apparatus 4032 is basically the same as the configuration example of the eigenvalue decomposition apparatus 10 according to the second example embodiment shown in FIG. 3, the configuration example of the eigenvalue decomposition apparatus 4032 will be described with reference to FIG. 3 while omitting the descriptions thereof as appropriate. The eigenvalue decomposition apparatus 4032 may be configured in such a way that the eigenvalue decomposition apparatus 20 according to the third example embodiment functions as channel correlation matrix eigenvalue decomposition means.

The eigenvalue decomposition apparatus 4032 includes a matrix generation unit 11, an eigenvalue decomposition unit 12, a matrix dimension reduction unit 13, an eigenvector combination unit 14, and a removal unit 15. Since the configuration of each of the matrix generation unit 11, the eigenvalue decomposition unit 12, the matrix dimension reduction unit 13, the eigenvector combination unit 14, and the removal unit 15 are basically similar to that in the second example embodiment, configurations that are different from those in the second example embodiment will be described while omitting the descriptions thereof as appropriate.

The matrix generation unit 11 receives a channel correlation matrix R on which the eigenvalue decomposition is to be performed from the correlation matrix calculation unit 4031 as a matrix A.

The eigenvector combination unit 14 outputs, when the number of eigenvectors of the determined matrix A is a predetermined number, the predetermined number of eigenvectors to the transmission signal generation unit 404. The predetermined number is, for example, the number T of the antennas 31 of the radio terminal 30.

When the number N of antennas 41 of the radio communication apparatus 40 is equal to or smaller than the number T of the antennas 31 of the radio terminal 30, the channel matrix H may be expressed as shown in Expression (9).

[Expression 21]

H=UΣV^{H} (9)

Note that Σ is a T×T-dimensional diagonal matrix having a singular value in a diagonal component, U is a T×T-dimensional left singular vector, and V is an N×T-dimensional right singular vector.

When the channel correlation matrix R is deployed using Expression (9), it can be expressed as shown in Expression (10). By performing eigenvalue decomposition of the channel correlation matrix R, the right singular vector V of the channel matrix H can be calculated.

[Expression 22]

R=H^{H}H=VΣU^{H}UΣV^{H}=VΛV^{H} (10)

Note that

Λ(=Σ²) [Expression 23]

indicates a diagonal matrix having an eigenvalue in a diagonal component.

The eigenvector combination unit 14 determines a predetermined number of eigenvectors to be the right singular vector V of the channel matrix H and outputs the predetermined number of eigenvectors to the transmission signal generation unit 404. In other words, the eigenvector combination unit 14 outputs the right singular vector V of the channel matrix H to the transmission signal generation unit 404.

Referring once again to FIG. 9, the transmission signal generation unit 404 will be described. The transmission signal generation unit 404 determines the weight coefficient W based on the predetermined number of eigenvectors output from the eigenvalue decomposition apparatus 4032. In other words, the transmission signal generation unit 404 determines the weight coefficient W based on the right singular vector of the channel matrix H. The transmission signal generation unit 404 selects, from a predetermined number of eigenvectors, eigenvectors whose number corresponds to the number of transmission layers L, and determines the weight coefficient W based on the selected eigenvectors. The transmission signal generation unit 404 selects, from the predetermined number of eigenvalues, eigenvectors whose number corresponds to the number of transmission layers L in an order, for example, from the largest eigenvalue, and determines the weight coefficient W. The weight coefficient W is an N×L-dimensional matrix and may be referred to as a BF weight matrix.

The transmission signal generation unit 404 performs processing such as encrypting, encoding, modulating, mapping onto radio resources, and the like for transmission data input from a core network (not shown). The transmission signal generation unit 404 multiples the baseband signal mapped onto radio resources by the weight coefficient W using the determined weight coefficient W and outputs the baseband signal multiplied by the weight coefficient W to the transmission/reception unit 401. Specifically, the transmission signal generation unit 404 multiplies the L-dimensional transmission signal vector by the weight coefficient W, thereby generating a signal multiplied by the weight coefficient W.

Note that the encoding method, the modulation mode, the method for mapping onto radio resources, and the like may be determined by a scheduler (not shown). The scheduler may perform the encoding method, the modulation mode, and the mapping onto radio resources using the estimated value of the channel response output from the channel estimation unit 402. Note that, since the scheduler is not directly related to the present disclosure, the description thereof is omitted in this specification.

Depending on the radio communication method used in the radio communication system 300, it may be necessary to perform processing such as an Inverse Fast Fourier Transform (IFFT), addition of CP between the transmission signal generation unit 404 and the transmission/reception unit 401. Therefore, a module that performs the above-described processing may be provided between the transmission signal generation unit 404 and the transmission/reception unit 401. In this specification, since this module is not directly related to the present disclosure, the illustration and description of the module are omitted.

### Operation Example of Radio Communication Apparatus

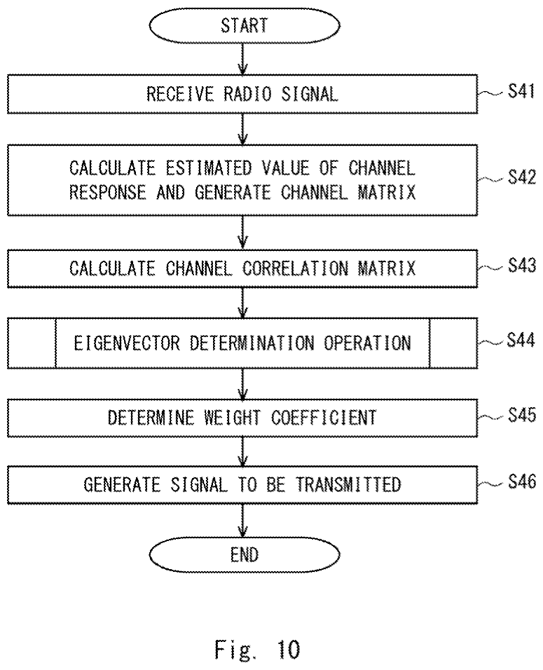

Referring to FIG. 10, an operation example of the radio communication apparatus 40 will be described. FIG. 10 is a flowchart showing an operation example of the radio communication apparatus according to the fourth example embodiment.

The antenna 41 receives a radio signal including a reference signal transmitted from the radio terminal 30 (Step S41). The transmission/reception unit 401 converts the radio signal input from the antenna 41 into a baseband signal.

The channel estimation unit 402 calculates an estimated value of the channel response between each of the antennas 41_1 to 41_N and each of the antennas 31_1 to 31_T using the received reference signal and generates a channel matrix H having the estimated values of the channel response as the respective elements (Step S42).

The correlation matrix calculation unit 4031 calculates a product of the Hermitian transpose of the channel matrix and the channel matrix H and thus calculates a channel correlation matrix R (Step S43).

The eigenvalue decomposition apparatus 4032 receives the channel correlation matrix R as the matrix A, performs an eigenvalue decomposition operation, and outputs a predetermined number of eigenvectors to the transmission signal generation unit 404 (Step S44).

The transmission signal generation unit 404 determines the weight coefficient W based on a predetermined number of eigenvectors (Step S45).

The transmission signal generation unit 404 generates a signal multiplied by the weight coefficient W (Step S46). The transmission signal generation unit 404 multiplies a modulation signal mapped onto radio resources by the weight coefficient W using the determined weight coefficient W and outputs the modulation signal by which the weight coefficient W is multiplied to the transmission/reception unit 401. The transmission/reception unit 401 converts the baseband signal input from the transmission signal generation unit 404 into a radio signal and outputs this radio signal to the antenna 41. The antenna 41 transmits the radio signal to the radio terminal 30.

Next, Step S44 in FIG. 10 will be described. As described above, in the eigenvalue decomposition apparatus 4032, the eigenvalue decomposition apparatus 10 according to the second example embodiment functions as eigenvalue decomposition means in the radio communication apparatus 40. Since an operation example of the eigenvalue decomposition apparatus 4032 is basically similar to the operation example of the eigenvalue decomposition apparatus 10 according to the second example embodiment shown in FIG. 5, Step S44 will be described, but with some omissions, with reference to FIG. 5.

The matrix generation unit 11 receives the channel correlation matrix R on which the eigenvalue decomposition is to be performed from the correlation matrix calculation unit 4031 as a matrix A (Step S11).

In Step S23, the eigenvector combination unit 14 outputs, when the number of eigenvectors of the determined matrix A is a predetermined number, the predetermined number of eigenvectors to the transmission signal generation unit 404 (Step S23). The predetermined number is, for example, the number of antennas 31 of the radio terminal 30. Therefore, the eigenvector combination unit 14 outputs eigenvectors whose number corresponds to the number of antennas 31 to the transmission signal generation unit 404.

As described above, in this example embodiment, the radio communication apparatus 40 in which the eigenvalue decomposition apparatus 10 according to the second example embodiment is used as the eigenvalue decomposition apparatus 4032 has been described. As described in the second example embodiment, by using the eigenvalue decomposition apparatus 4032, it is possible to reduce the amount of computation required for the eigenvalue decomposition and perform eigenvalue decomposition at a high speed. Accordingly, with the radio communication apparatus 40 according to the fourth example embodiment, it is possible to determine the weight coefficient used for eigenmode transmission within the time required in the radio communication system.

### Other Example Embodiments

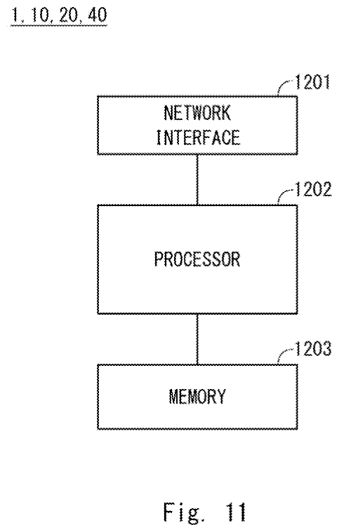

FIG. 11 is a diagram showing a hardware configuration example of the eigenvalue decomposition apparatus 1, 10, and 20, and the radio communication apparatus 40 (hereinafter they are referred to as the eigenvalue decomposition apparatus 1 and the like) described in the aforementioned example embodiments. Referring to FIG. 11, the eigenvalue decomposition apparatus 1 etc. include a network interface 1201, a processor 1202, and a memory 1203. The network interface 1201 is used to communicate with another communication apparatus included in an information processing system or a radio communication system.

The processor 1202 loads software (computer program) from the memory 1203 and executes the loaded software (computer program), thereby performing processing of the eigenvalue decomposition apparatus 1 and the like described using the flowchart in the aforementioned example embodiments. The processor 1202 may be, for example, a microprocessor, a Micro Processing Unit (MPU), or a Central Processing Unit (CPU). The processor 1202 may include a plurality of processors.

The memory 1203 is formed of a combination of a volatile memory and a non-volatile memory. The memory 1203 may include a storage located apart from the processor 1202. In this case, the processor 1202 may access the memory 1203 via an Input (I)/Output (O) interface (no shown).

In the example shown in FIG. 11, the memory 1203 is used to store software modules. The processor 1202 loads these software modules from the memory 1203 and executes the loaded software modules, thereby performing processing of the eigenvalue decomposition apparatus 1 and the like described in the above example embodiments.

As described above with reference to FIG. 11, each of the processors included in the eigenvalue decomposition apparatus 1 and the like executes one or more programs including instructions for causing a computer to execute the algorithm described with reference to the drawings.

In the aforementioned examples, the programs can be stored and provided to a computer using any type of non-transitory computer readable media. Non-transitory computer readable media include various types of tangible storage media. Examples of the non-transitory computer readable media include magnetic storage media (such as flexible disks, magnetic tapes, hard disk drives, etc.), optical magnetic storage media (e.g., magneto-optical disks). Examples of the non-transitory computer readable media further include CD-Read Only Memory (ROM), CD-R, and CD-R/W. Examples of the non-transitory computer readable media further include semiconductor memories. The semiconductor memories include, for example, mask ROM, Programmable ROM (PROM), Erasable PROM (EPROM), flash ROM, Random Access Memory (RAM). The programs may be provided to a computer by using any type of transitory computer readable media. Examples of the transitory computer readable media include electric signals, optical signals, and electromagnetic waves. The transitory computer readable media can provide the program to a computer via a wired communication line (e.g., electric wires and optical fibers) or a wireless communication line.

The terms User Equipment (UE) (or a mobile station), mobile terminal, mobile device, or radio terminal (wireless device), or the like are entities connected to a network via a wireless interface.

The present disclosure is not limited to a special-purpose communication apparatus and may be applied to any device including the following communication function.

The terms “User Equipment” or “UE” (as the term is used by 3GPP), “mobile station”, “mobile terminal”, “mobile device”, and “radio terminal” are generally intended to be synonymous with one another. The UE may include standalone mobile stations, such as terminals, cell phones, smart phones, tablets, cellular internet of things (IoT) terminals, and IoT devices. It will be appreciated that the terms “mobile station”, “mobile terminal”, and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper projecting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motorcycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; a loud speaker; a radio; video equipment; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to “internet of things (IoT)”, using a variety of wired and/or wireless communication technologies.

IoT devices (or “things”) may be equipped with appropriate electronics, software, sensors, network connectivity, and/or the like, which enable these devices to collect and exchange data with each other and with other communication devices.

IoT devices may comprise automated equipment that follow software instructions stored in an internal memory.

IoT devices may operate without requiring human supervision or interaction.

IoT devices might also remain stationary and/or inactive for a long period of time.

IoT devices may be implemented as a part of a stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices, or Machine-to-Machine (M2M) communication devices.

It will be appreciated that a UE may support one or more IoT or MTC applications.

Some examples of MTC applications are listed in the following table (source: 3GPP TS22.368 V13.2.0 (2017-Jan.-13), Annex B, the contents of which are incorporated herein by reference). This list is not exhaustive and is intended to be indicative of some examples of MTC applications.

TABLE 1

| Service Range | MTC Applications |
|---|---|
| Security | Surveillance systems |
| | Backup for landline |
| | Control of physical access (e.g., to buildings) |
| | Car/driver security |
| Tacking & Tracing | Fleet Management |
| | Order Management |
| | Telematics insurance: Pay as you drive (PAYD) |
| | Asset Tracking |
| | Navigation |
| | Traffic information |
| | Road tolling |
| | Road traffic optimisation/steering¥ |
| Payment | Point of sales (POS) |
| | Vending machines |
| | Gaming machines |
| Health | Monitoring vital signs |
| | Supporting the aged or handicapped |
| | Web Access Telemedicine points |
| | Remote diagnostics |
| Remote Maintenance/ | Sensors |
| Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an Mobile Virtual Network Operator (MVNO) service/system, an emergency radio communication service/system, a Private Branch eXchange (PBX) service/system, a PHS/Digital Cordless Telecommunications service/system, a Point of sale (POS) service/system, an advertise calling service/system, a Multimedia Broadcast and Multicast Service (MBMS) service/system, a Vehicle to Everything (V2X) service/system, a train radio service/system, a location related service/system, a Disaster/Emergency Wireless Communication Service/system, an Internet of Things (IoT) service/system, a community service/system, a video streaming service/system, a femto cell application service/system, a Voice over LTE (VoLTE) service/system, a radio tag service/system, a charging service/system, a radio on demand service/system, a roaming service/system, a user activity monitoring service/system, a telecom carrier/communication NW selection service/system, a functional restriction service/system, a Proof of Concept (PoC) service/system, a personal information management service/system for terminals, a display video service/system for terminals, a non-communication service/system for terminals, an ad-hoc NW/Delay Tolerant Networking (DTN) service/system, etc.

The above-described UE categories are merely examples of applications of the technical ideas and example embodiments described in the present disclosure. The UE described in this disclosure is not limited to these examples and various modifications can be made thereto by those skilled in the art.

Further, the present disclosure is not limited to the aforementioned example embodiments and may be changed as appropriate without departing from the spirit of the present disclosure. Further, the present disclosure may be executed by combining the example embodiments as appropriate.

Further, the whole or part of the example embodiments disclosed above can be described as, but not limited to, the following supplementary notes.

### (Supplementary Note 1)

An eigenvalue decomposition apparatus comprising:
first generation means for inputting a first matrix and generating a 2×2-dimensional third matrix using a plurality of elements included in a second matrix based on the first matrix;
first calculation means for calculating a two-dimensional eigenvector that corresponds to a maximum eigenvalue of the third matrix;
first update means for generating a fourth matrix obtained by reducing the dimension of the second matrix by using the two-dimensional eigenvector, updating the second matrix based on the fourth matrix, and determining, when the number of elements included in the fourth matrix is one, the element included in the fourth matrix to be an eigenvalue of the first matrix; and
second calculation means for determining the eigenvector of the first matrix using the two-dimensional eigenvectors calculated before the number of elements included in the fourth matrix becomes one.

### (Supplementary Note 2)

The eigenvalue decomposition apparatus according to Supplementary Note 1, wherein the first generation means extracts a diagonal element in the i (i: an integer equal to or larger than one)-th row and the i-th column, a diagonal element in the j (j: an integer equal to or larger than one, i<j)-th row and the j-th column, a non-diagonal element in the i-th row and the j-th column, and a non-diagonal element in the j-th row and i-th column included in the second matrix, and generates the third matrix using the extracted elements.

### (Supplementary Note 3)

The eigenvalue decomposition apparatus according to Supplementary Note 1, wherein the first generation means extracts, from the second matrix, an element included in a row vector in the i (i: an integer equal to or larger than one)-th row and an element included in a row vector in the j (j: an integer equal to or larger than one, i<j)-th row, or an element included in a column vector in the i-th column and an element included in a column vector in the j-th column, and generates the third matrix using the extracted elements.

### (Supplementary Note 4)

The eigenvalue decomposition apparatus according to Supplementary Note 3, wherein the first generation means determines the element to be extracted from the second matrix based on a correlation between the row vector in the i-th row and the row vector in the j-th row or a correlation between the column vector in the i-th column and the column vector in the j-th column.

### (Supplementary Note 5)

The eigenvalue decomposition apparatus according to Supplementary Note 2 or 3, wherein the first generation means determines an element to be extracted from the second matrix based on the magnitude of the non-diagonal elements of the second matrix.

### (Supplementary Note 6)

The eigenvalue decomposition apparatus according to any one of Supplementary Notes 2 to 5, wherein the first update means composes the row vector in the i-th row of the second matrix and the row vector in the j-th row of the second matrix using two elements included in the two-dimensional eigenvectors, and composes the column vector in the i-th column of the second matrix and the column vector in the j-th column of the second matrix, thereby generating the fourth matrix.

### (Supplementary Note 7)

The eigenvalue decomposition apparatus according to any one of Supplementary Notes 1 to 6, wherein the second calculation means determines the eigenvector of the first matrix using a unit matrix whose dimension is the same as that of the first matrix and two elements included in each of the two-dimensional eigenvectors calculated before the number of elements included in the fourth matrix becomes one.

### (Supplementary Note 8)

The eigenvalue decomposition apparatus according to any one of Supplementary Notes 1 to 7, further comprising removal means for removing a component that corresponds to the eigenvalue of the first matrix from the first matrix and updating the first matrix based on the matrix from which the component has been removed.

### (Supplementary Note 9)

The eigenvalue decomposition apparatus according to any one of Supplementary Notes 1 to 8, further comprising second update means for performing calculation on the first matrix by a power method using the eigenvector of the first matrix as an initial vector and updating the eigenvalue and the eigenvector.

### (Supplementary Note 10)

A radio communication apparatus comprising:
the eigenvalue decomposition apparatus according to any one of Supplementary Notes 1 to 7;
channel estimation means for estimating a channel response between the radio communication apparatus and a radio terminal and generating a channel matrix based on the estimated channel response;
correlation matrix calculation means for calculating the first matrix using the channel matrix; and
transmission signal generation means for determining a weight coefficient based on the eigenvector and generating a signal multiplied by the weight coefficient, wherein
the eigenvalue decomposition apparatus further comprises removal means for removing a component that corresponds to the eigenvalue of the first matrix from the first matrix and updating the first matrix based on a matrix obtained by removing the component from the first matrix,
the second calculation means outputs, when the number of eigenvectors becomes a predetermined number, the predetermined number of eigenvectors, and
the transmission signal generation means determines the weight coefficient based on the predetermined number of eigenvectors.

### (Supplementary Note 11)

The radio communication apparatus according to Supplementary Note 10, wherein the eigenvalue decomposition apparatus further comprises second update means for performing calculation on the first matrix by a power method using the eigenvector as an initial vector and updating the eigenvalue and the eigenvector of the first matrix.

### (Supplementary Note 12)

A method comprising:
inputting a first matrix and generating a 2×2-dimensional third matrix using at least one element included in a second matrix based on the first matrix;
calculating a two-dimensional eigenvector that corresponds to a maximum eigenvalue of the third matrix;
generating a fourth matrix obtained by reducing the dimension of the second matrix by using the two-dimensional eigenvector, updating the second matrix based on the fourth matrix, and determining, when the number of elements included in the fourth matrix is one, the element included in the fourth matrix as a first eigenvalue of the first matrix; and
determining the eigenvector of the first matrix using the two-dimensional eigenvectors calculated before the number of elements included in the fourth matrix becomes one.

### (Supplementary Note 13)

The method according to Supplementary Note 12, further comprising repeating the generation of the third matrix, the calculation of the two-dimensional eigenvector, and the update of the second matrix until when the number of elements included in the fourth matrix becomes one.

### (Supplementary Note 14)

The method according to Supplementary Note 12 or 13, further comprising:
estimating a channel response between a radio communication apparatus and a radio terminal and generating a channel matrix based on the estimated channel response;
calculating the first matrix using the channel matrix;
removing a component that corresponds to the eigenvalue of the first matrix from the first matrix and updating the first matrix based on a matrix obtained by removing the component from the first matrix;
outputting, when the number of eigenvectors becomes a predetermined number, the predetermined number of eigenvectors; and
determining a weight coefficient based on the predetermined number of eigenvectors and generating a signal by which the weight coefficient is multiplied.

### (Supplementary Note 15)

The method according to Supplementary Note 14, further comprising repeating the generation of the third matrix, the calculation of the two-dimensional eigenvector, the update of the second matrix, and the update of the first matrix until when the number of eigenvectors becomes a predetermined number.

### (Supplementary Note 16)

A non-transitory computer readable medium storing a program for causing a computer to execute the following processing of:
inputting a first matrix and generating a 2×2-dimensional third matrix using at least one element included in a second matrix based on the first matrix;
calculating a two-dimensional eigenvector that corresponds to a maximum eigenvalue of the third matrix;
generating a fourth matrix obtained by reducing the dimension of the second matrix by using the two-dimensional eigenvector, updating the second matrix based on the fourth matrix, and determining, when the number of elements included in the fourth matrix is one, the element included in the fourth matrix as a first eigenvalue of the first matrix; and
determining the eigenvector of the first matrix using the two-dimensional eigenvectors calculated before the number of elements included in the fourth matrix becomes one.

### (Supplementary Note 17)

The non-transitory computer readable medium according to Supplementary Note 16, wherein the program includes repeating the generation of the third matrix, the calculation of the two-dimensional eigenvector, and the update of the second matrix until when the number of elements included in the fourth matrix becomes one.

### (Supplementary Note 18)

The non-transitory computer readable medium according to Supplementary Note 16 or 17, wherein the program further comprises:
estimating a channel response between a radio communication apparatus and a radio terminal and generating a channel matrix based on the estimated channel response;
calculating the first matrix using the channel matrix;
removing a component that corresponds to the eigenvalue of the first matrix from the first matrix and updating the first matrix based on a matrix obtained by removing the component from the first matrix;
outputting, when the number of eigenvectors becomes a predetermined number, the predetermined number of eigenvectors; and
determining a weight coefficient based on the predetermined number of eigenvectors and generating a signal by which the weight coefficient is multiplied.

### (Supplementary Note 19)

The non-transitory computer readable medium according to Supplementary Note 18, wherein the program further includes repeating the generation of the third matrix, the calculation of the two-dimensional eigenvector, the update of the second matrix, and the update of the first matrix until when the number of eigenvectors becomes a predetermined number.

### REFERENCE SIGNS LIST

1, 10, 20, 4032 EIGENVALUE DECOMPOSITION APPARATUS
2 FIRST GENERATION UNIT
3 FIRST CALCULATION UNIT
4 FIRST UPDATE UNIT
5 SECOND CALCULATION UNIT
11 MATRIX GENERATION UNIT
12 EIGENVALUE DECOMPOSITION UNIT
13 MATRIX DIMENSION REDUCTION UNIT
14 EIGENVECTOR COMBINATION UNIT
15 REMOVAL UNIT
21 POWER METHOD CALCULATION UNIT
30 RADIO TERMINAL
31_1 to 31_T, 41_1-41_N ANTENNA
40 RADIO COMMUNICATION APPARATUS
50 INPUT/OUTPUT APPARATUS
100, 200 INFORMATION PROCESSING SYSTEM
300 RADIO COMMUNICATION SYSTEM
401 TRANSMISSION/RECEPTION UNIT
402 CHANNEL ESTIMATION UNIT
403 BF WEIGHT GENERATION UNIT
404 TRANSMISSION SIGNAL GENERATION UNIT
4031 CORRELATION MATRIX CALCULATION UNIT

What is claimed is:

1. An eigenvalue decomposition apparatus comprising:
at least one memory storing instructions, and
at least one processor configured to execute the instructions to;
input a first matrix and generating a 2×2-dimensional third matrix using a plurality of elements included in a second matrix based on the first matrix;
calculate a two-dimensional eigenvector that corresponds to a maximum eigenvalue of the third matrix;
generate a fourth matrix obtained by reducing the dimension of the second matrix by using the two-dimensional eigenvector, update the second matrix based on the fourth matrix, and determine, when the number of elements included in the fourth matrix is one, the element included in the fourth matrix to be an eigenvalue of the first matrix; and
determine the eigenvector of the first matrix using the two-dimensional eigenvectors calculated before the number of elements included in the fourth matrix becomes one.

2. The eigenvalue decomposition apparatus according to claim 1, wherein the at least one processor is configured to extract a diagonal element in the i (i: an integer equal to or larger than one)-th row and the i-th column, a diagonal element in the j (j: an integer equal to or larger than one, i<j)-th row and the j-th column, a non-diagonal element in the i-th row and the j-th column, and a non-diagonal element in the j-th row and i-th column included in the second matrix, and generates the third matrix using the extracted elements.

3. The eigenvalue decomposition apparatus according to claim 1, wherein the at least one processor is configured to extract, from the second matrix, an element included in a row vector in the i (i: an integer equal to or larger than one)-th row and an element included in a row vector in the j (j: an integer equal to or larger than one, i<j)-th row, or an element included in a column vector in the i-th column and an element included in a column vector in the j-th column, and generates the third matrix using the extracted elements.

4. The eigenvalue decomposition apparatus according to claim 3, wherein the at least one processor is configured to determine the element to be extracted from the second matrix based on a correlation between the row vector in the i-th row and the row vector in the j-th row or a correlation between the column vector in the i-th column and the column vector in the j-th column.

5. The eigenvalue decomposition apparatus according to claim 2, wherein the at least one processor is configured to determine an element to be extracted from the second matrix based on the magnitude of the non-diagonal elements of the second matrix.

6. The eigenvalue decomposition apparatus according to claim 2, wherein the at least one processor is configured to compose the row vector in the i-th row of the second matrix and the row vector in the j-th row of the second matrix using two elements included in the two-dimensional eigenvectors, and compose the column vector in the i-th column of the second matrix and the column vector in the j-th column of the second matrix, thereby generating the fourth matrix.

7. The eigenvalue decomposition apparatus according to claim 1, wherein the at least one processor is configured to determine the eigenvector of the first matrix using a unit matrix whose dimension is the same as that of the first matrix and two elements included in each of the two-dimensional eigenvectors calculated before the number of elements included in the fourth matrix becomes one.

8. The eigenvalue decomposition apparatus according to claim 1, the at least one processor is further configured to remove a component that corresponds to the eigenvalue of the first matrix from the first matrix and update the first matrix based on the matrix from which the component has been removed.

9. The eigenvalue decomposition apparatus according to claim 1, the at least one processor is further configured to perform calculation on the first matrix by a power method using the eigenvector of the first matrix as an initial vector and update the eigenvalue and the eigenvector.

10-11. (canceled)

12. A method comprising:
inputting a first matrix and generating a 2×2-dimensional third matrix using at least one element included in a second matrix based on the first matrix;
calculating a two-dimensional eigenvector that corresponds to a maximum eigenvalue of the third matrix;
generating a fourth matrix obtained by reducing the dimension of the second matrix by using the two-dimensional eigenvector, updating the second matrix based on the fourth matrix, and determining, when the number of elements included in the fourth matrix is one, the element included in the fourth matrix as a first eigenvalue of the first matrix; and
determining the eigenvector of the first matrix using the two-dimensional eigenvectors calculated before the number of elements included in the fourth matrix becomes one.

13. The method according to claim 12, further comprising repeating the generation of the third matrix, the calculation of the two-dimensional eigenvector, and the update of the second matrix until when the number of elements included in the fourth matrix becomes one.

14. The method according to claim 12, further comprising:
estimating a channel response between a radio communication apparatus and a radio terminal and generating a channel matrix based on the estimated channel response;
calculating the first matrix using the channel matrix;
removing a component that corresponds to the eigenvalue of the first matrix from the first matrix and updating the first matrix based on a matrix obtained by removing the component from the first matrix;
outputting, when the number of eigenvectors becomes a predetermined number, the predetermined number of eigenvectors; and
determining a weight coefficient based on the predetermined number of eigenvectors and generating a signal by which the weight coefficient is multiplied.

15. The method according to claim 14, further comprising repeating the generation of the third matrix, the calculation of the two-dimensional eigenvector, the update of the second matrix, and the update of the first matrix until when the number of eigenvectors becomes a predetermined number.

16. A non-transitory computer readable medium storing a program for causing a computer to execute the following processing of:
inputting a first matrix and generating a 2×2-dimensional third matrix using at least one element included in a second matrix based on the first matrix;
calculating a two-dimensional eigenvector that corresponds to a maximum eigenvalue of the third matrix;
generating a fourth matrix obtained by reducing the dimension of the second matrix by using the two-dimensional eigenvector, updating the second matrix based on the fourth matrix, and determining, when the number of elements included in the fourth matrix is one, the element included in the fourth matrix as a first eigenvalue of the first matrix; and
determining the eigenvector of the first matrix using the two-dimensional eigenvectors calculated before the number of elements included in the fourth matrix becomes one.

17. The non-transitory computer readable medium according to claim 16, wherein the program includes repeating the generation of the third matrix, the calculation of the two-dimensional eigenvector, and the update of the second matrix until when the number of elements included in the fourth matrix becomes one.

18. The non-transitory computer readable medium according to claim 16, wherein the program further comprises:
estimating a channel response between a radio communication apparatus and a radio terminal and generating a channel matrix based on the estimated channel response;
calculating the first matrix using the channel matrix;
removing a component that corresponds to the eigenvalue of the first matrix from the first matrix and updating the first matrix based on a matrix obtained by removing the component from the first matrix;
outputting, when the number of eigenvectors becomes a predetermined number, the predetermined number of eigenvectors; and
determining a weight coefficient based on the predetermined number of eigenvectors and generating a signal by which the weight coefficient is multiplied.

19. The non-transitory computer readable medium according to claim 18, wherein the program further includes repeating the generation of the third matrix, the calculation of the two-dimensional eigenvector, the update of the second matrix, and the update of the first matrix until when the number of eigenvectors becomes a predetermined number.
